(19) United States
(12) Patent Application Publication
(10) Pub. No.: US 2015/0294062 A1
(43) Pub. Date: Oct. 15, 2015

(54) Method for Identifying a Target Molecular Profile Associated with a Target Cell Population

(71) Applicant: ONTARIO INSTITUTE FOR CANCER RESEARCH (OICR), Toronto (CA)

(72) Inventors: Gerald Quon, Toronto (CA); Syed Haider, Toronto (CA); Ang Cui, Toronto (CA); Paul C. Boutros, Toronto (CA); Quaid D. Morris, Toronto (CA)

(73) Assignee: ONTARIO INSTITUTE FOR CANCER RESEARCH (OICR), Toronto, ON (CA)

(21) Appl. No.: 14/439,629

(22) PCT Filed: Oct. 29, 2013
(86) PCT No.: PCT/CA2013/000925

§ 371 Date: Apr. 29, 2015

Related U.S. Application Data
(60) Provisional application No. 61/719,631, filed on Oct. 29, 2012.

(51) Int. Cl. G06F 19/12; G06F 19/00

(52) U.S. Cl. CPC G06F 19/12; G06F 19/3431

(57) ABSTRACT

A method for identifying a target molecular profile associated with a target cell population. A set of reference molecular profiles and a set of sample molecular profiles are received. Each sample molecular profile is associated with a sample cell from a sample cell population, which includes a mixture of target cells and reference cells. Each of the sample molecular profiles is indicative of a respective target molecular profile. An average target molecular profile is calculated. A proportion value is calculated for each sample molecular profile. A respective target molecular profile is calculated for each sample molecular profile based on the respective calculated proportion value and a closest similarity to the average target molecular profile.

### RELATED APPLICATIONS

The present application claims priority to U.S. Provisional Patent Application No. 61/719,631 filed on Oct. 29, 2012, which is incorporated herein by reference.

### TECHNICAL FIELD

The present disclosure relates generally to methods and systems for identifying molecular profiles associated with certain cell populations. The present disclosure also relates generally to methods and system for identifying biomarkers associated with certain cell populations. The present disclosure may be suitable for use in cancer detection and predicting cancer outcomes, as well as the response of cancer tumors and cancer patients to therapies and/or treatments.

### BACKGROUND

Therapeutic strategies for cancer have traditionally involved systemic treatments roughly guided by morphological features such as tumor size, spread, and histology¹. Heterogeneity has been observed in prognosis and response to treatment within patient groups defined by these traditional covariates. There is currently interest in personalized treatment regimens based on molecular features of tumors².

Genomic technologies can generate tumor molecular biomarker profiles containing thousands or millions of measurements that may provide a comprehensive snapshot of tumor state. Gene expression-based biomarkers (also referred to as “signatures”) have demonstrated an ability to sub-categorize cancer types³⁻⁶, predict patient prognosis⁷⁻¹² and response to treatment^{13, 14} and identify tumor site of origin^{15, 16}. Some of these signatures have been in clinical use¹⁷⁻¹⁹ or trials²⁰.

However, tumor heterogeneity remains a barrier to the development and clinical application of molecular diagnostics. For example, many bulk tumors infiltrate healthy tissue in highly irregular three-dimensional patterns, making it difficult if not impossible to isolate cancerous cells from healthy tissue during surgery or biopsy. The proportion of healthy tissue in a tumor sample may vary considerably both within and between tumors²¹, spanning the entire range of 0% to almost 100%^{22, 23.} Median healthy tissue contamination levels of 30-90% have been reported for lung adenocarcinomas and prostate tumors^{24, 25} pre-selected for microarray analysis^{27, 28}.

The variability in tumor profiles introduced by this healthy tissue contamination may reduce the effective sample size of profiling studies, introduce confounding transcriptional signals even in moderately impure samples²⁶ and restrict the clinical use of these models to patients whose tumors fit a pre-defined healthy tissue limit threshold.

Increasing the number of samples profiled in biomarker studies in hopes of averaging out the inter-tumoral variability resulting from differing amounts of healthy tissue^{27, 28} has not adequately addressed this problem: even studies totaling over 400 samples have not produced prognostic models that can consistently predict patient risk above random chance²⁷. Varying levels of healthy tissue contamination is a likely contributing factor of the failure of many expression-based signatures to be validated on independent patient cohorts of a variety of tumor types^{27, 29, 30}. The systematic noise introduced by healthy tissue contamination is distinct from instrumentation (i.e., measurement) noise and is not addressed by current preprocessing methods, yet affects all analyses of bulk solid tumor samples.

### SUMMARY

In some aspects, the present disclosure provides a method in a processor for identifying a target molecular profile associated with a target cell population comprising: receiving data signals representing a set (β) of one or more reference molecular profiles (βₖ) each associated with at least one of one or more reference cell populations; receiving data signals representing a set (t) of one or more sample molecular profiles (t_{d}) each associated with a sample cell (d) from a sample cell population, the sample cell population including a mixture of target cells and reference cells, each of the sample molecular profiles (t_{d}) being indicative of a respective target molecular profile (γ^{d}); calculating an estimated average target molecular profile (γ′) from the set (t); for each sample molecular profile (t_{d}), calculating a proportion value (θ_{d}) including a proportion value (θ_{d,c}) representing a proportion of the sample molecular profile (t_{d}) that is attributable to the average target molecular profile (γ′); for each sample molecular profile (t_{d}), calculating a respective target molecular profile (γ^{d}) based on the respective calculated proportion value (θ_{d,c}) and a closest similarity to the average target molecular profile (γ′); and providing as output data signals representing the target molecular profiles (γ^{d}).

In some aspects, the present disclosure provides a method in a processor for identifying at least one biomarker associated with a target cell population comprising: receiving data signals representing a set (β) of one or more reference molecular profiles (βₖ) each associated with a respective one of one or more reference cell populations; receiving data signals representing a set (γ) of one or more target molecular profiles (γ_{d}) associated with the target cell population, the target molecular profiles (γ_{d}) being obtained according to the method described above; receiving data signals representing a set (p) of at least one attribute associated with at least one target molecular profile (γ_{d}); comparing the set (γ) to the set (β) to determine the at least one biomarker for predicting the at least one attribute; and generating output signals representing the at least one determined biomarker.

In some aspects, the present disclosure provides for systems comprising a processor configured to execute computer-executable instructions to cause the processor to carry out the methods described above.

### BRIEF DESCRIPTION OF THE DRAWINGS

Reference will now be made to the drawings, which show by way of example embodiments of the present disclosure, and in which:

FIG. 1 is a flowchart illustrating an example of the disclosed methods for identifying a target molecular profile associated with a target cell population;

FIG. 2 is a flowchart illustrating an example of the disclosed methods for identifying at least one biomarker associated with a target cell population;

FIG. 3 is a conceptualization of an example of the disclosed methods;

FIG. 4 is a schematic illustrating the use of an example of the disclosed methods in prognostic models;

FIG. 5 shows charts illustrating comparisons of computationally-predicted and pathologist-evaluated tumor composition of lung and prostate tumors;

FIG. 6 shows charts showing the predicted tumor compositions, using an example of the disclosed methods, for three lung cancer datasets;

FIG. 7 shows charts illustrating the performance of example prognostic models, with or without using various computational purification strategies;

FIG. 8 shows charts illustrating the performance of example prognostic model on Stage I or Stage IB only patients, with or without using an example of the disclosed methods;

FIG. 9 shows charts illustrating the performance of example prognostic models, based on either unpurified expression profiles, purified expression profiles calculated by an example of the disclosed methods, or 50 mixing proportion weights estimated by an example of the disclosed methods;

FIG. 10 are charts illustrating gene expression profiles before and after purification using an example of the disclosed methods;

FIG. 11a shows a chart illustrating estimates of proportion variables, using an example of the disclosed methods;

FIG. 11b shows a chart illustrating the number of tumor samples in which each normal molecular profile was estimated to explain at least 1% of the sample molecular expression profile;

FIG. 12 shows charts illustrating the correlation of percentage cancerous tissue calculated using an example of the disclosed methods with pathologist estimates;

FIG. 13 is a chart illustrating the test set performance of an example of the disclosed methods as a function of Source Panel size; and

FIG. 14 is a chart showing the application of the method on RNA-Seq data and its close concordance to DNA-based measurements of tumour cellularity.

### DETAILED DESCRIPTION

The disclosed methods and systems help to provide a computational method that removes the variability caused by healthy tissue contamination. The disclosed methods and systems include a sample-specific purification procedure. Applying the disclosed methods and systems as a pre-processing step to remove the impact of healthy tissue on the tumor gene expression profile has been found to improve the predictive accuracy of prognostic models for both lung and prostate cancer, for example. The disclosed methods and systems may also be used to estimate the proportion of the quantified RNA sample contributed by cancerous tissue. This estimate has been found to be correlated with pathologists' estimates of tumor cellularity. The disclosed methods and systems may only require expression profiles of possible healthy tissue contaminants in the tumor sample, and, as such, may be applied to a wide variety of new and archival tumor profiling datasets derived using diverse-omic technologies.

Methods and systems are described for identifying target molecular profiles associated with target cell populations. The identified profiles may be further used to identify biomarkers for the target cell populations. The present disclosure refers to identifying cancerous tumor expression profiles, as examples, and presents studies of lung and prostate tumors. Identification of tumor expression profiles may be useful in prognosis of cancer in patients.

Tumor stage may be used as a patient covariate to predict patient prognosis. It may be useful to test gene expression levels (and other genomic covariates) as patient covariates because they may be used to directly query tumor state and may be more high dimensional than clinical covariates, thus providing more opportunities to find predictive covariates.

The disclosed methods and systems may identify or provide biomarkers that may be useful for predictive, prognostic and/or diagnostic applications, for example for cancer detection, for predicting cancer outcomes, and/or for predicting the response of cancer tumors and patients to therapies and treatments.

The disclosed methods and systems may be used for deconvolution of tumor profiles, which may help to improve performance of expression-based prognostic models by reducing the inter-tumor and intra-tumor variation caused by normal cell contamination. This deconvolution may be addressed as a particular constrained problem: given a dataset of N expression profiles (profiling G genes) corresponding to N individuals with cancers from the same primary site, how to estimate N cancer expression profiles (profiling G genes) that have reduced inter-tumor variation in gene expression due to contaminating normal cells.

The disclosed methods and systems may help to address this problem and may provide for one or more of the following:

The disclosed methods and systems may help to determine patient-specific tumor expression profiles over G genes, and therefore may retain the high dimensionality of expression profiles for input to prognostic models.

The disclosed methods and systems may not require matched normal samples. Matched normal tissue from the same patient is often unavailable in both clinical and research settings. Even when available, profiling matched tissue typically doubles assay costs and there is no guarantee that it will be an accurate representation of the contaminating normal tissue. As such, conventional methods that require matched normal samples may be less useful than those that can use unmatched normals.

The disclosed methods and systems may not require tumor composition (i.e., mixture proportions of cancer and normal cells) as input information. Although approximate cell counts of normal versus cancer cells may be obtained by visual inspection by pathologists or by using automated image-processing software, this may introduce an additional delay in the diagnostic cycle and it may be difficult to guarantee consistency among different pathologists and/or image-processing algorithms. In fact, these cell counts may not even be useful for in silico purification. Also, these mixture proportions may be relatively rare in public tumor datasets.

The disclosed methods and systems may help to improve prediction of patient prognosis, as well as patient diagnosis.

In the examples, healthy tissue expression profiles are accepted as input for the method and these are used to deconvolve the tumor sample expression profile into contributions from healthy and cancerous tissue. In example studies, an example of the disclosed methods is validated by comparing its estimates of percentage cancerous tissue within a sample to those assessed by pathologists on two independent cohorts. The example method is also studied to demonstrate its ability to improve the predictive accuracy of expression-based prognostic models for patient survival in non-small cell lung cancer and extraprostatic extension in prostate cancer.

The present disclosure refers to “molecular profiles”, meaning the levels of biological molecules exhibited by cells in a sample. This molecular expression typically results from RNA and DNA of the cells in the sample, but may also include protein and/or other molecules. A molecular profile may be determined by measuring occurrences or concentrations of certain molecules that are exhibited by the cells.

A molecular profile may be determined using measurements of occurrences or concentrations of unique molecules including, for example: transcripts (e.g., messenger RNAs, microRNAs, transfer RNAs, ribosomal RNAs, long non-coding RNAs, other RNAs and mixtures thereof), proteins, peptides, metabolites, genetic polymorphisms (e.g., single nucleotide polymorphisms, copy number variations, small insertions, small deletions and mixtures thereof), metabolites (e.g., sugars, lipids and cofactors) and mixtures thereof.

A molecular profile may be determined using any suitable technique. For example, for measuring occurrences or concentrations of transcripts, reverse transcriptase polymerase chain reaction (RT-PCR), NanoString nCounter assays, microarray or RNA-sequencing techniques may be used. For measuring occurrences or concentrations of proteins, peptides and/or metabolites, mass spectrometry techniques may be used. For measuring occurrences or concentrations of genetic polymorphisms, microarray or sequencing techniques may be used.

The present disclosure refers to “purification” of sample molecular profiles. By this, it is meant that sample molecular profiles, which may be a heterogeneous mixture of target molecular profiles and reference molecular profiles, are deconvolved to extract the target molecular profiles.

As used herein, “biological parameter” refers to any measurable or quantifiable characteristic in a biological system and includes, without limitation, physical characteristics and attributes, genotype, phenotype, biomarkers, gene expression, splice-variants of an mRNA, polymorphisms of DNA or protein, levels of protein, cells, nucleic acids, amino acids or other biological matter.

The term “biomarker” as used herein refers to a biological parameter (e.g., a gene) that differs between or within individuals. For example, specifically with respect to non-small cell lung cancer, the biomarkers may be differentially expressed in individuals according to prognosis and thus may be predictive of different survival outcomes and of the benefit of various therapies and treatments, such as adjuvant chemotherapy.

The term “level of expression” or “expression level” as used herein refers to a measurable level of expression of the products of biomarkers, such as, without limitation, the level of messenger RNA transcript expressed or of a specific exon or other portion of a transcript, the level of proteins or portions thereof expressed of the biomarkers, the number or presence of DNA polymorphisms of the biomarkers, the enzymatic or other activities of the biomarkers, and the level of specific metabolites.

As used herein, the term “control” refers to a specific value or dataset that can be used to prognose or classify the value (e.g., expression level or reference expression profile obtained from the test sample associated with an outcome class). In one embodiment, a dataset may be obtained from samples from a group of subjects known to have non-small cell lung cancer and good survival outcome or known to have non-small cell lung cancer and have poor survival outcome or known to have non-small cell lung cancer and have benefited from adjuvant chemotherapy or known to have non-small cell lung cancer and not have benefited from adjuvant chemotherapy or known to not have non-small cell lung cancer.

A person skilled in the art will appreciate that the comparison between the expression of the biomarkers in the test sample and the expression of the biomarkers in the control will depend on the control used. For example, if the control is from a subject known to have non-small cell lung cancer and poor survival, and there is a difference in expression of the biomarkers between the control and test sample, then the subject can be prognosed or classified in a good survival group. If the control is from a subject known to have non-small cell lung cancer and good survival, and there is a difference in expression of the biomarkers between the control and test sample, then the subject can be prognosed or classified in a poor survival group. For example, if the control is from a subject known to have non-small cell lung cancer and good survival, and there is a similarity in expression of the biomarkers between the control and test sample, then the subject can be prognosed or classified in a good survival group. For example, if the control is from a subject known to have non-small cell lung cancer and poor survival, and there is a similarity in expression of the biomarkers between the control and test sample, then the subject can be prognosed or classified in a poor survival group.

The term “differentially expressed” or “differential expression” as used herein refers to a difference in the level of expression of the biomarkers that can be assayed by measuring the level of expression of the products of the biomarkers, such as the difference in level of messenger RNA transcript or a portion thereof expressed or of proteins expressed of the biomarkers. In a preferred embodiment, the difference is statistically significant. The term “difference in the level of expression” refers to an increase or decrease in the measurable expression level of a given biomarker, for example as measured by the amount of messenger RNA transcript and/or the amount of protein in a sample as compared with the measurable expression level of a given biomarker in a control.

The term “similarity in expression” as used herein means that there is no or little difference in the level of expression of the biomarkers between the test sample and the control or reference profile. For example, similarity can refer to a fold difference compared to a control. In a preferred embodiment, there is no statistically significant difference in the level of expression of the biomarkers.

The term “most similar” in the context of a reference profile refers to a reference profile that is associated with a clinical outcome that shows the greatest number of identities and/or degree of changes with the subject profile.

The term “prognosis” as used herein refers to a clinical outcome group such as a poor survival group or a good survival group associated with a disease subtype which is reflected by a reference profile such as a biomarker reference expression profile or reflected by an expression level of the biomarkers disclosed herein. The prognosis provides an indication of disease progression and includes an indication of likelihood of death due to lung cancer. In one embodiment the clinical outcome class includes a good survival group and a poor survival group.

The term “prognosing or classifying” as used herein means predicting or identifying the clinical outcome group that a subject belongs to according to the subject's similarity to a reference profile or biomarker expression level associated with the prognosis. For example, prognosing or classifying comprises a method or process of determining whether an individual with non-small cell lung cancer has a good or poor survival outcome, or grouping an individual with non-small cell lung cancer into a good survival group or a poor survival group, or predicting whether or not an individual with non-small cell lung cancer will respond to therapy.

The term “good survival” as used herein refers to an increased chance of survival as compared to patients in the “poor survival” group. For example, the biomarkers of the application can prognose or classify patients into a “good survival group”. These patients are at a lower risk of death after surgery or another treatment protocol.

The term “poor survival” as used herein refers to an increased risk of death as compared to patients in the “good survival” group. For example, biomarkers or genes of the application can prognose or classify patients into a “poor survival group”. These patients are at greater risk of death or adverse reaction from disease or surgery, treatment for the disease or other causes.

The term “subject” as used herein refers to any member of the animal kingdom, preferably a human being and most preferably a human being that has non-small cell lung cancer or that is suspected of having non-small cell lung cancer.

The term “test sample” as used herein refers to any fluid, cell or tissue sample derived from a subject and which can be assayed for biomarker expression products and/or a reference expression profile, e.g. genes differentially expressed in subjects with non-small cell lung cancer according to survival outcome.

The phrase “determining the expression of biomarkers” as used herein refers to determining or quantifying RNA or proteins or protein activities or protein-related metabolites expressed by the biomarkers. The term “RNA” includes mRNA transcripts, and/or specific spliced or other alternative variants of mRNA, including anti-sense products. The term “RNA product of the biomarker” as used herein refers to RNA transcripts transcribed from the biomarkers and/or specific spliced or alternative variants. In the case of “protein”, it refers to proteins translated from the RNA transcripts transcribed from the biomarkers. The term “protein product of the biomarker” refers to proteins translated from RNA products of the biomarkers.

A person skilled in the art will appreciate that a number of methods can be used to detect or quantify the level of RNA products of the biomarkers within a sample, including arrays, such as microarrays, RT-PCR (including quantitative RT-PCR), NanoString nCounter assays, nuclease protection assays and Northern blot analyses.

Accordingly, in one embodiment, the biomarker expression levels are determined using arrays, optionally microarrays, RT-PCR, optionally quantitative RT-PCR, NanoString nCounter assays, nuclease protection assays or Northern blot analyses.

The term “nucleic acid” includes DNA and RNA and can be either double stranded or single stranded.

The term “hybridize” or “hybridizable” refers to the sequence specific non-covalent binding interaction with a complementary nucleic acid. In a preferred embodiment, the hybridization is under high stringency conditions. Appropriate stringency conditions which promote hybridization are known to those skilled in the art, or can be found in Current Protocols in Molecular Biology, John Wiley & Sons, N.Y. (1989), 6.3.1 6.3.6. For example, 6.0× sodium chloride/sodium citrate (SSC) at about 45° C., followed by a wash of 2.0×SSC at 50° C. may be employed.

The term “probe” as used herein refers to a nucleic acid sequence that will hybridize to a nucleic acid target sequence. In one example, the probe hybridizes to an RNA product of the biomarker or a nucleic acid sequence complementary thereof. The length of probe depends on the hybridization conditions and the sequences of the probe and nucleic acid target sequence. In one embodiment, the probe is at least 8, 10, 15, 20, 25, 50, 75, 100, 150, 200, 250, 400, 500 or more nucleotides in length.

The term “primer” as used herein refers to a nucleic acid sequence, whether occurring naturally as in a purified restriction digest or produced synthetically, which is capable of acting as a point of synthesis when placed under conditions in which synthesis of a primer extension product, which is complementary to a nucleic acid strand is induced (e.g. in the presence of nucleotides and an inducing agent such as DNA polymerase and at a suitable temperature and pH). The primer must be sufficiently long to prime the synthesis of the desired extension product in the presence of the inducing agent. The exact length of the primer will depend upon factors, including temperature, sequences of the primer and the methods used. A primer typically contains 15-25 or more nucleotides, although it can contain less or more. The factors involved in determining the appropriate length of primer are readily known to one of ordinary skill in the art.

In addition, a person skilled in the art will appreciate that a number of methods can be used to determine the amount of a protein product of the biomarker of the invention, including immunoassays such as Western blots, ELISA, and immunoprecipitation followed by SDS-PAGE and immunocytochemistry.

The gene signature described herein can be used to select treatment for non-small cell lung cancer patients. As explained herein, the biomarkers can classify patients with non-small cell lung cancer into a poor survival group or a good survival group and into groups that might benefit from adjuvant chemotherapy or not.

The term “adjuvant chemotherapy” as used herein means treatment of cancer with chemotherapeutic agents after surgery where all detectable disease has been removed, but where there still remains a risk of small amounts of remaining cancer. Typical chemotherapeutic agents include cisplatin, carboplatin, vinorelbine, gemcitabine, doccetaxel, paclitaxel and navelbine.

In an aspect, there is provided a method of prognosing or classifying a subject with non-small cell lung cancer, preferably adenocarcinoma, comprising: determining the expression of at least one biomarker outlined in Table 1 in a test sample from the subject; and comparing expression of the at least one biomarker in the test sample with expression of the at least one biomarker in a control sample; wherein a difference or similarity in the expression of the at least one biomarker between the control and the test sample is used to prognose or classify the subject with non-small cell lung cancer into a poor survival group or a good survival group.

In preferable embodiments, the at least one biomarker is, in increasing preferability, from 2 to 110 biomarkers.

In some embodiments, the level of gene expression is determined and compared. The level of gene expression may be determined by hybridizing a labeled probe to the at least one of biomarker. Preferably, the level of gene expression is determined on a microarray. In some embodiments, the method further comprises polymerase chain reaction (PCR) to amplify the mRNA and/or quantitative PCR. In some embodiments, the level of gene expression may be determined by counting the number of sequenced tags derived from fragments of the RNA transcript of the gene, for example using a process referred to as RNA-seq.

In another embodiment, the level of gene expression is determined by using a tag based analysis, preferably serial analysis of gene expression (SAGE) or RNA-seq.

In some embodiments, the level of protein expression is determined and compared. Preferably, the level of protein expression is determined by binding the at least one biomarker to antibody specific to the at least one biomarker and detecting the presence of the resulting protein-antibody complex.

In an aspect, there is provided a method of selecting a therapy for a subject with non-small cell lung cancer, comprising the steps: classifying the subject with non-small cell lung cancer into a poor survival group or a good survival group according to the methods disclosed herein; and selecting adjuvant chemotherapy for the poor survival group or no adjuvant chemotherapy for the good survival group.

In an aspect, there is provided a method of selecting a therapy for a subject with non-small cell lung cancer, comprising the steps: determining the expression of at least one biomarker outlined in Table 1 in a test sample from the subject; comparing the expression of the at least one biomarker in the test sample with the same biomarker in a control sample; classifying the subject in a poor survival group or a good survival group, wherein a difference or a similarity in the expression of the at least three biomarkers between the control sample and the test sample is used to classify the subject into a poor survival group or a good survival group; selecting adjuvant chemotherapy if the subject is classified in the poor survival group and selecting no adjuvant chemotherapy if the subject is classified in the good survival group.

In an aspect, there is provided a composition comprising a plurality of isolated nucleic acid sequences, wherein each isolated nucleic acid sequence hybridizes to: a RNA product of at least one of the genes outlined in outlined in Table 1; and/or a nucleic acid complementary to a), wherein the composition is used to measure the level of RNA expression of the genes.

In an aspect, there is provided an array comprising, for each of at least one of the biomarkers outlined in Table 1, one or more polynucleotide probes complementary and hybridizable to an expression product of the gene.

In an aspect, there is provided a kit to prognose or classify a subject with non-small cell lung cancer, comprising detection agents that can detect the expression products of at least one of the biomarkers outlined in Table 1, and instructions for use.

In an aspect, there is provided a kit to select a therapy for a subject with non-small cell lung cancer, comprising detection agents that can detect the expression products of at least one of the biomarkers outlined in Table 1, and instructions for use.

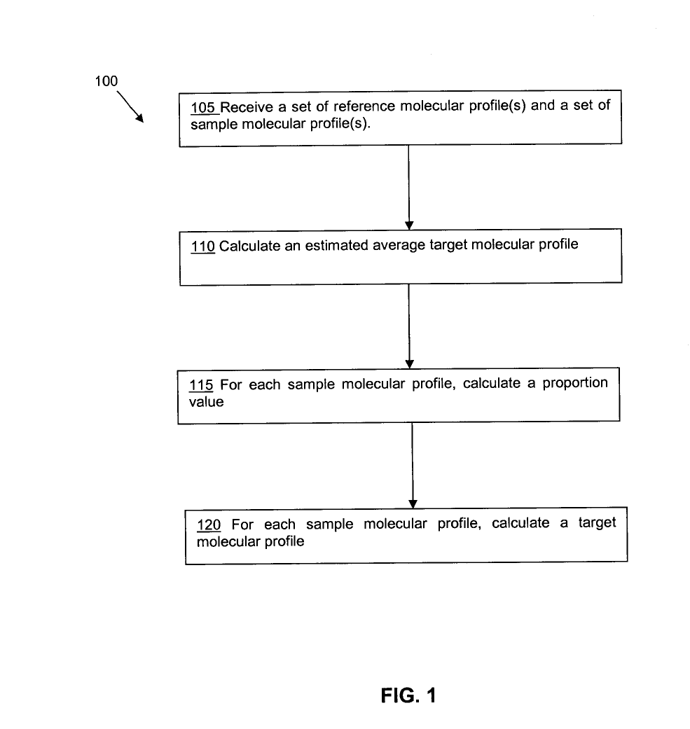

Reference is made to FIG. 1, showing a flowchart of an example method 100 for identifying a target molecular profile associated with a target cell population. The method 100 may be carried out using any suitable processor (e.g., as found in a desktop, laptop, workstation or other processing device). The processor may be coupled to a memory (e.g., RAM, ROM, removable memory, external memory, storage media such as a CD or DVD) or otherwise receive instructions (e.g., from an external source, such as in cloud computing) to cause the processor to carry out the method 100. The method 100 may be carried out by one or more processors, for example different portions of the method 100 may be carried out by different processors. The method may be carried out by a system including one or more processors that execute computer-executable instructions. The system may include one or more databases.

At 105, input data signals are received providing input information. The input information may include a set (t) of one or more sample molecular profiles (t_{d}) and a set (β) of one or more reference molecular profiles (βₖ). Throughout this disclosure, molecular profiles may also be referred to as profiles, for simplicity. Each reference molecular profile (βₖ) may be associated with a respective reference cell population. One or more reference molecular profiles (βₖ) may be retrieved from a database of molecular profiles or obtained by other suitable methods, such as through computational estimation. Each sample molecular profile (t_{d}) may be associated with a sample cell (d) from a sample cell population. Typically, the sample cell population may include a mixture of target cells and reference cells. Each of the sample molecular profiles (t_{d}) may be indicative of a respective target molecular profile (γ^{d}).

For example, where the method 100 is used for purification of cancer tumor profiles, the sample molecular profile(s) (t_{d}) may be heterogeneous tumor sample profile(s) to purify, and the reference molecular profile(s) (βₖ) may be molecular profile(s) of healthy tissue samples. The aim in such a case may be to obtain purified tumor molecular profile(s) (γ^{d}) from the heterogeneous sample profile(s).

The reference molecular profile(s) (βₖ) may be representative of one or more reference tissues that are known to be other than the target tissue(s) (e.g., healthy tissues rather than cancerous tissues) and are possible contaminants in the sample tissue(s). The reference molecular profile(s) (βₖ) may be taken from reference tissue(s) that are known to be related to the sample tissue(s), for example the reference tissue(s) may be healthy tissue surrounding the sample tissue.

The set (β) of reference molecular profile(s) (βₖ) may be used to estimate the molecular profile(s) (γ^{d}) of the target tissue(s) (e.g., the tumor tissue) in each heterogeneous sample molecular profile (t_{d}).

At least one of the sample molecular profile(s) (t_{d}) and/or at least one of the reference molecular profile(s) (βₖ) may be received from a database or by any other suitable methods, including estimation methods. For example, a database of molecular profiles for healthy tissue may be queried to obtain the reference molecular profile(s) (βₖ). The sample molecular profile(s) (t_{d}) may be obtained from a new or current biopsy of a patient, for example, and/or from historical or archival databases of sample molecular profiles.

The reference molecular profile(s) (βₖ), in some examples, may be obtained through biops(ies), retrieved from a database of molecular profiles for healthy tissues or by any other suitable method, including computational estimation methods, for example. A database of molecular profiles may be created from accumulated samples of molecular profiles of healthy tissues of different organs from different patients. Thus, the disclosed methods and systems may not be restricted to using reference molecular profile(s) (βₖ) from the same patient.

At 110 an estimate of an average target molecular profile (γ′) is calculated from the set (t) of sample molecular profile(s) (t_{d}). The average target molecular profile (γ′) may be considered representative of the actual target molecular profile (γ^{d}) for each sample profile (t_{d}). For example, where the target molecular profile (γ^{d}) is a purified cancer tumor profile, an average tumor profile (γ′) may be estimated that is considered to be representative of the pure tumor profile (γ^{d}) for each sample profile.

This calculation may be carried out by calculating maximum a posteriori (MAP) estimates for a global average target profile (γ′) shared by all input sample profiles (t_{d}). The average target profile (γ′) may be modeled as being sampled from a Dirichlet distribution whose mean parameter vector may be constructed from the set of reference profiles and whose concentration parameter is fit to the target profile data. That is, this estimation may be based on the assumption that the average target profile (γ′) is similar to the set (β) of reference molecular profile(s) (βₖ) (e.g., based on the assumption that cancerous tissue has expression profiles that are similar to those of healthy tissue from which the cancer is derived).

In some examples, the average target molecular profile (γ′) may be calculated by constraining the average target molecular profile (γ′) to be close to a predefined prior mean vector. The prior mean vector may be defined as a weighted combination of the reference profiles (e.g., as described below). In an example method for constraining average target molecular profile (γ′) to be close to a predefined prior mean vector, differences between the average target molecular profile (γ′) and the mean prior vector may be penalized using a Dirichlet prior, for example, in which the mean prior vector constitutes the mean parameter vector and the strength parameter is either pre-defined or is selected through an automated procedure to maximize the likelihood of the collection of mixed samples (y_{d}) under the model.

For example, the set (β) of reference profile(s) (βₖ) may be used to define a reference molecular profile space comprising a set of reference weighted averages (ωβ), where all values of (ω) are non-negative and the sum of all (ω) equal to one. The average target molecular profile (γ′) may then be calculated by constraining the average target molecular profile (γ′) to maximize a probability that each sample molecular profile (t_{d}) is generated based on a combination of the set (β) of reference molecular profile(s) (βₖ) and the average target molecular profile (γ′), and also by constraining the average molecular profile (γ′) to be close to the set of reference weighted averages (ωβ).

At 115, for each sample molecular profile (t_{d}), a respective proportion value (θ_{d}) is calculated, resulting in a set (θ) of one or more proportion values (θ_{d}). Each proportion value (θ_{d}) may include a proportion value (θ_{d,c}) representing a proportion of the sample molecular profile (t_{d}) that is attributable to the average target molecular profile (γ′). The calculation of the proportion value(s) (θ_{d}) may be based on using the average target molecular profile (γ′) as representative of each actual target molecular profile (γ^{d}). This may be based on the assumption that the target molecular profile(s) (γ^{d}) are relatively similar to each other. For example, where the target molecular profile (γ^{d}) is a pure tumor profile, it may be assumed that all tumor profiles in the samples are relatively similar to each other.

In some examples, the proportion value(s) (θ_{d}) may be calculated by constraining each (θ_{d}) to be close to an average (α) of all (θ_{d}).

In some examples, a proportion value (θ_{d,k}) representing a proportion of each reference molecular profile (βₖ) expressed in a given sample molecular profile (t_{d}) may also be calculated.

At 120, for each sample molecular profile (t_{d}), a respective target molecular profile (γ^{d}) is calculated based on: (i) the respective proportion value (θ_{d,c}) and (ii) a closest similarity to the average target molecular profile (γ′).

For example, the target molecular profile (γ^{d}) may be calculated by constraining the target molecular profile (γ^{d}) to maximize a probability that the respective sample molecular profile (t_{d}) is generated based on a combination of the set of reference molecular profile(s) (β) and the target molecular profile (γ^{d}), and by constraining the target molecular profile (γ^{d}) to be close to the average target molecular profile (γ′).

The set of sample molecular profile(s) (γ^{d}) may thus be determined. Output signals representing the set of sample molecular profile(s) (γ^{d}) may be provided, for example to be displayed on a screen to a user, to be stored in a memory for future use and/or to be transmitted to one or more other processors for further processing.

In some examples, steps 110 and 115 may be carried out substantially concurrently, in a different order and/or iteratively. In some examples, the steps of method 100 may be carried out by separate processors and/or at different times. For example, steps 105-115 may be carried out at a workstation in advance. Step 120 may then be carried out at a separate workstation and/or at a future time.

In the example method 100, each sample molecular profile (t_{d}) may include n measurements of occurrences or concentrations for respective ones of a plurality of unique molecular expressions (W). These unique molecular expressions (W) may be, for example, unique transcripts (e.g., messenger RNAs, microRNAs, transfer RNAs, ribosomal RNAs, long non-coding RNAs, other RNAs or a mixture thereof), unique proteins, unique peptides, unique metabolites, genetic polymorphisms (e.g., single nucleotide polymorphisms, copy number variations, small insertions, small deletions and mixtures thereof), certain metabolites (e.g., sugars, lipids, and cofactors) and mixtures thereof. In the case of transcripts, the occurrences or concentrations of transcripts may be measured using any suitable method including, for example, reverse transcriptase polymerase chain reaction (RT-PCR), NanoString nCounter assays, microarrays, nuclease protection assays, Northern blot analyses and RNA-sequencing. In the case of proteins, peptides and metabolites, occurrences or concentrations may be measured using mass spectrometry or any other suitable method. In the case of genetic polymorphisms, occurrences or concentrations may be measured using any suitable technique including, for example, using microarrays or sequencing.

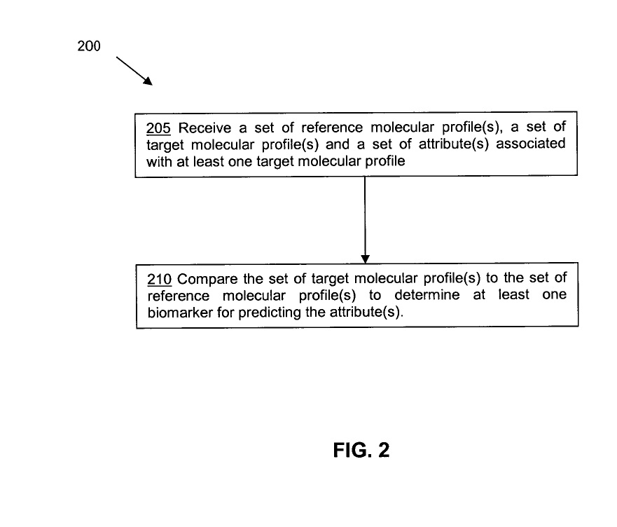

Reference is now made to FIG. 2, showing a flowchart illustrating a method 200 for identifying at least one biomarker associated with a target cell population. The method 200 may use the results calculated using the method 100, for example. The method 200 may be carried out immediately after the method 100 or may be carried out at a different time. The method 200 may be carried out using the same or different processor(s) and/or system(s) as the method 100. In some examples, the processor(s) for carrying out the method 200 may have access to one or more databases containing the target molecular profile(s) (γ_{d}) calculated by the method 100. The processor(s) for carrying out the method 200 may additionally have access to one or more databases storing data for the reference molecular profile(s) (βₖ).

At 205, input data signals representing input information is received. The input information includes the set (β) of one or more reference molecular profiles (βₖ), the set (γ) of one or more target molecular profiles (γ_{d}) associated with the target cell population (e.g., where the target molecular profiles (γ_{d}) are obtained according to the method 100), and a set (p) of one or more attribute(s) associated with at least one target molecular profile (γ_{d}).

Where the target profiles are cancer tumor profiles, examples of attributes may include: risk of death, risk of cancer recurrence, response to specific therapies, the presence of absence of toxicity (or other side-effects caused by therapy), tumor stage, tumor site of origin, tumor grade, microenvironmental characteristics of the tumor (e.g., hypoxia), tumor growth rate, activation or inactivation of specific molecular pathways (e.g., activation of Ras signaling or abrogation of TP53 signaling), and any other suitable patient attribute. These may be useful attributes to be considered since these attributes may be useful in predicting patient outcomes and therefore in planning treatment. For example, patients deemed to have higher risk of death may be given more adjuvant therapy.

At 210, the set (γ) is compared to the set (β) to determine at least one biomarker for predicting the attribute(s). Output data signals representing the at least one determined biomarker are then provided, for example to be displayed on a screen, to be stored in a memory for future use, and/or to be transmitted to one or more other processors for further processing.

By determining the biomarker(s) that are predictive of attribute(s) of interest, a patient may be readily categorized according to risk using the patient's sample profile. A suitable treatment plan may then be prepared.

The biomarker(s) may also be used to distinguish a cell from the reference cell population from a cell from the target cell population.

In some examples, attribute(s) associated with one target molecular profile may be independent of any attribute(s) associated with another target molecular profile. In some examples, there may be one or more target molecular profiles with no associated attribute in the set (p).

### Example Statistical Model

The example method 100 will be described with respect to statistical models. In particular, the example method 100 will be described with applications for purifying gene expression profiles that characterize heterogeneous tumor samples.

Typically, tissue samples taken from solid tumors of cancer patients are heterogeneous and contain mixtures of tumor cells and healthy cells. The presence of infiltrating healthy cells may introduce artifacts into the gene expression profile, which may limit their use in diagnostics. The disclosed methods and systems may be used to perform in silico purification of tumor expression profiles.

A molecular (or transcriptional) profile may be defined as a 1×W vector of observed counts of a particular molecule (e.g., specific gene or specific transcript), in a sample. For profiles generated by de novo sequencing technologies, these counts may represent the number of sequence reads that have mapped to a particular gene; for microarray experiments, these observed counts may be the intensity values of each gene.

A normalized profile may also be defined, in which all entries of the 1×W vector have been divided by the total number of observed counts, such that the counts sum to 1. Normalized profiles may be useful as parameters to a multinomial distribution.

The disclosed methods and systems may provide determination or estimation of a cancer expression profile (γ^{d}) for every input tumor profile (x_{d}). (γ^{d}) represents the profile of the cancer cells in tumor sample d, whereas the tumor profile (t_{d}) may include contributions of the contaminating healthy or reference cells.

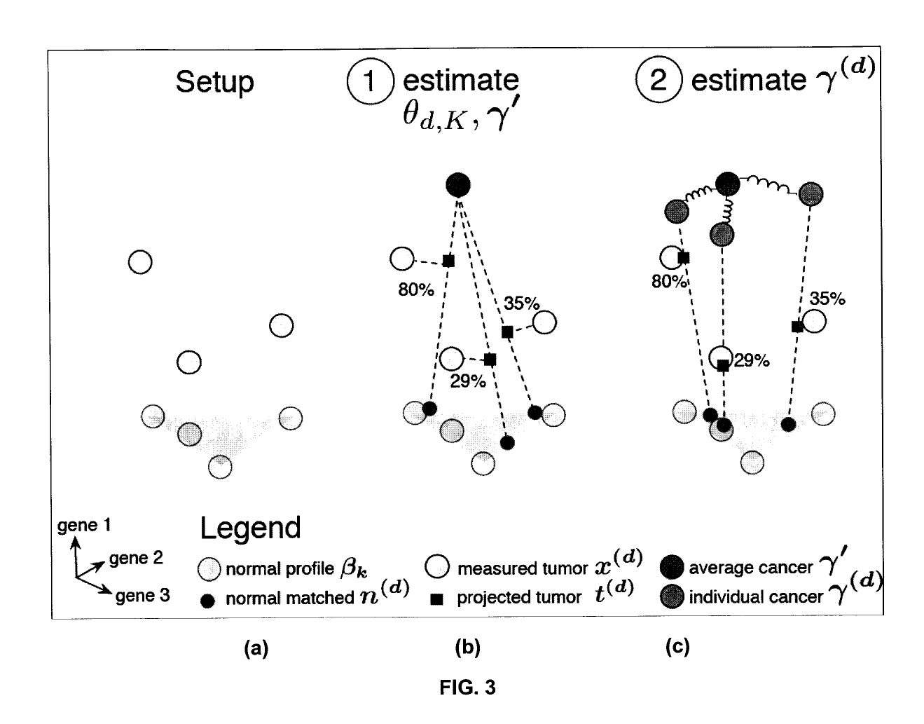

For simpler conceptualization, the example method may be as a two-phase inference and learning procedure, as geometrically represented in FIG. 3.

FIG. 3 shows a geometric interpretation of the statistical model of the example method. (a) The input to the model includes a set of heterogeneous tumor samples (t_{d}) from the same site of origin, and a set of normal profiles comprising the Source Panel, (βₖ) that are drawn from the primary site (i.e., site of origin of the tumor). (b) In phase one the average cancer profile (γ′) is calculated across all input tumors, as well as the fractional cancer RNA content in each sample, (θ_{d,k}). (c) In phase two per-tumor cancer expression profiles (γ^{d}) are calculated by constraining the calculation towards the average cancer profile (γ′) (as illustrated by the spring).

The statistical model and constrains may help to address the underdetermined system of equations of expression deconvolution through parameter regularization, as described below. Conceptually, the method may be thought of as assuming that the per-tumor cancer expression profiles (γ^{d}) are similar to the average cancer profile (γ′) estimated, and the average cancer profile (γ′) may be used to regularize the per-tumor cancer profiles (γ^{d}) to prevent over-fitting.

As described above, input information includes molecular (in this example, transcriptional) profiles of D heterogeneous tumor samples to be purified, {t_{d,n}}. Each profile d may be characterized by a total set of N_{d} transcript counts, where t_{d,n} refers to the nth transcript count for tumor sample d. t_{d,n} is in the set {1, . . . , W} where W is the total number of unique transcripts/genes being profiled.

Another input is a panel of reference normalized profiles of healthy tissue that may contaminate the heterogeneous tumor samples, the set of reference profiles being β={β₁; . . . ; βₖ}. For example, healthy lung tissue profiles could be used as β profiles when purifying lung tumor samples.

Another input may be matrix τ in the set R^{P×W}, specifying P normalized profiles. These P normalized profiles may be from the healthy site of origin of the tumor, and may be used to determine the gene expression state of the cancer cells before carcinogenesis started (termed the cell of origin). For tumors whose site of origin is the same as the tissue in which it is located, τ=|β₁; . . . ; βₖ|.

The disclosed methods and systems provide, as output, purified (and possibly normalized) tumor expression profiles γ^{d} in the set R^{W}, each representing a row vector for which one per input heterogeneous tumor sample d is saved. These profiles may be normalized. In order to undo the normalization procedure, each parameter (normalized count) may be divided by the fractional tumor content of the original heterogeneous tumor sample to re-scale the count to have the same units as the original profile, for example. Other normalization procedures that have been applied (e.g., transformations in log-space and scaling into Z-score space, among others) may also be undone.

Another output may be, for each heterogeneous tumor sample d, the mixture proportions θ_{d} in the set R^{K+1}. θ_{d,k} for k in the set {1, . . . , K} corresponds to the contaminant K from the source panel, while θ_{d,K+1} is the percentage tumor content.

Another output may be the average tumor profile, γ′ in the set R^{W}, representing the “average” pure tumor state of all D heterogeneous tumor samples.

In this example, the statistical model may estimate one or more model parameters.

For every tumor sample d, the example model estimates κ_{d} in the set of R⁺, which is a positive constant representing the strength of the similarity between the purified tumor profile γ^{d} and the average tumor profile γ′. This may be based on calculations using a Dirichlet prior as described above, for example.

There is also estimated parameter κ′ which is a positive constant that indicates the strength of similarity between the average tumor profile γ′ and the cell of origin state ω^{T}τ.

ω is a vector of length P non-negative values, called weights, that sum to 1, that represents the weights used to compute a convex combination of the component profiles of τ to estimate the cell of origin state.

The example model also contains nuisance latent variables z_{d,n} in the set R^{K+1} that are summed over during inference. z_{d,n} denotes which of the source panel contaminants (or the pure tumor cell population) that transcript t_{d,n} comes from. That is, z^{k}_{d,n}=1 when transcript t_{d,n} came from source k (the pure tumor cells are assumed to be source K+1).

### Example Equations

In the example method based on the example statistical model, the average cancer profile (γ′) may be estimated as well as the fraction of each tumor's RNA attributable to cancer (θ_{d,k}), using the following model:

p(θ_{d}|α)=Dirichlet(θ_{d}|α,1)

p(z_{d,n}|θ_{d})=Discrete(z_{d,n}|θ_{d})

P(t_{d,n}|z_{d,n}=k,β,γ′,k<K)=Discrete(t_{d,n}|βₖ)

P(t_{d,n}|z_{d,n}×k,βγ′,k=K)=Discrete(t_{d,n}γ′)

p(γ′|ω,κ′,τ)=Dirichlet(γ′|τω,κ′)

The complete log likelihood function is given by

$$ln p ( t , θ , {γ}^{′} \vert α , β , {κ}^{′} , ω , τ ) = ln p ( {γ}^{′} \vert ω , {κ}^{′} , τ ) + {\sum }_{d = 1}^{D} [ ln p ( {θ}_{d} \vert α ) + ( {\sum }_{n = 1}^{{N}_{d}} ln P ( {t}_{d , n} \vert {θ}_{d} , β , {γ}^{′} ) ) ]$$

$$where$$

$$P ( {t}_{d , n} \vert {θ}_{d} , {γ}^{′} ) = {\sum }_{k = 1}^{K} P ( {t}_{d , n} \vert {z}_{d , n} = k , β , {γ}^{′} ) P ( {z}_{d , n} = k \vert {θ}_{d} ) = {\sum }_{k = 1}^{K} {β}_{{t}_{d , n} , k} {θ}_{d , k}$$

The complete log likelihood may be optimized for all hidden variables and model parameters (γ′, ω, κ′, α, and θ) in any suitable manner, for example in an iterative fashion using suitable derivatives, and using suitable threshold constraints. The log likelihood function may be iteratively maximized over all variables (e.g., for 35 iterations of conjugate gradient descent). More or less iterations may be suitable, for example depending on the degree of accuracy desired. Other convex optimization approaches may be suitable as well. Because the complete log likelihood function is multi-modal, the quality of the solution (as assessed via value of the log likelihood at convergence) may vary depending on the initial values of the parameters. As such, multiple restarts may be required to find a good local maximum of the complete log likelihood.

In this example, having estimated the average profile (γ′) and the associated tumor content of each sample (θ_{d,k}), the actual pure tumor profiles of each sample (γ^{d}) may be determined. The cancer proportion for each sample (θ_{d,k}) is fixed and the following model is used:

p(θ_{d}|α)=Dirichlet(θ_{d}|α,1)

p(z_{d,n}|θ_{d})→Discrete(z_{d,n}|θ_{d})

P(t_{d,n}|z_{d,n}=k,β,γ^{d},k<K)=Discrete(t_{d,n}|βₖ)

P(t_{d,n}|z_{d,n}=k,β,γ^{d},k=K)=Discrete(t_{d,n}γ^{d})

p(γ^{d}|κ^{d},γ′)Dirichlet(γ^{d}|γ′,κ^{d})

The complete log likelihood function to be maximized is given by

$$ln p ( t , θ , {γ}^{d} , {γ}^{′} \vert α , β , {κ}^{d} , {κ}^{′} , ω ) = {\sum }_{d = 1}^{D} ln p ( {γ}^{d} \vert {κ}^{d} , {γ}^{′} ) + ln p ( {θ}_{d} \vert α ) + ( {\sum }_{n = 1}^{{N}_{d}} ln P ( {t}_{d , n} \vert {θ}_{d} , β , {γ}^{d} ) )$$

$$where$$

$$P ( {t}_{d , n} \vert {θ}_{d} , β , {γ}^{d} ) = {\sum }_{k = 1}^{K} P ( {t}_{d , n} \vert {z}_{d , n} = k , β , {γ}^{d} ) P ( {z}_{d , n} = k \vert {θ}_{d} ) = {\sum }_{k = 1}^{K} {β}_{{t}_{d , n} , k}^{d} {θ}_{d , k}$$

As above, the complete log likelihood may be numerically optimized for all hidden variables and model parameters in any suitable manner, for example in an iterative fashion using suitable derivatives, and using suitable constraints. As above, the log likelihood function may be iteratively maximized over all variables (e.g., for 35 iterations of conjugate gradient descent). More or less iterations may be suitable, for example depending on the degree of accuracy desired. Other convex optimization approaches may be suitable as well.

### Example Studies

Various studies were carried out on examples of the disclosed methods and systems. A study was designed to evaluate the estimates of tumor composition θ_{d,K} and per-tumor cancer profiles γ^{d} calculated using an example of the disclosed methods and systems, for example as described above. The tumor composition estimates were assessed using two datasets: a set of 127 lung tumors from Bhattacharjee et al.²⁴ and a set of 109 prostate tumors from Wang et al.²³. The prognostic value of purified (i.e., the actual target profiles) and unpurified (i.e., the sample profiles) expression profiles were tested using two datasets: the Beer et al.³³ dataset of 86 lung tumor profiles and the four cohorts from the Shedden dataset²⁷ of 443 lung tumor profiles.

Two sets of training and testing datasets were created to compare the prognostic performance of gene expression-based prognostic models. The first set used the Beer cohort as a training dataset, and all four Shedden cohorts as a testing dataset. The Beer and Shedden cohorts are distinct, and were profiled by different investigators, using different microarray platforms. This set was designed to maximize the number of patients in the test dataset, as the Shedden dataset is the largest set of lung tumor profiles collected using a single protocol. It also allowed testing on an independently collected cohort of patients, as per guidelines established for expression-based prognostic models³⁰. The second set split the four Shedden cohorts into a training dataset of 256 patients (composed of the HLM and MI cohorts) and a testing dataset of 186 patients (composed of the DFCI and MSKCC cohorts) as was done in the blind prediction challenge²⁷. This set allowed direct comparison of the results the study analysis to those published in the Shedden study. Also, because the cohorts were collected using the same protocol, there may be less intercohort batch effects in the expression profiles. The matrix factorization approach was also tested for identifying patient covariates because the number of normal samples associated with each of the four cohorts was the same (49 samples).

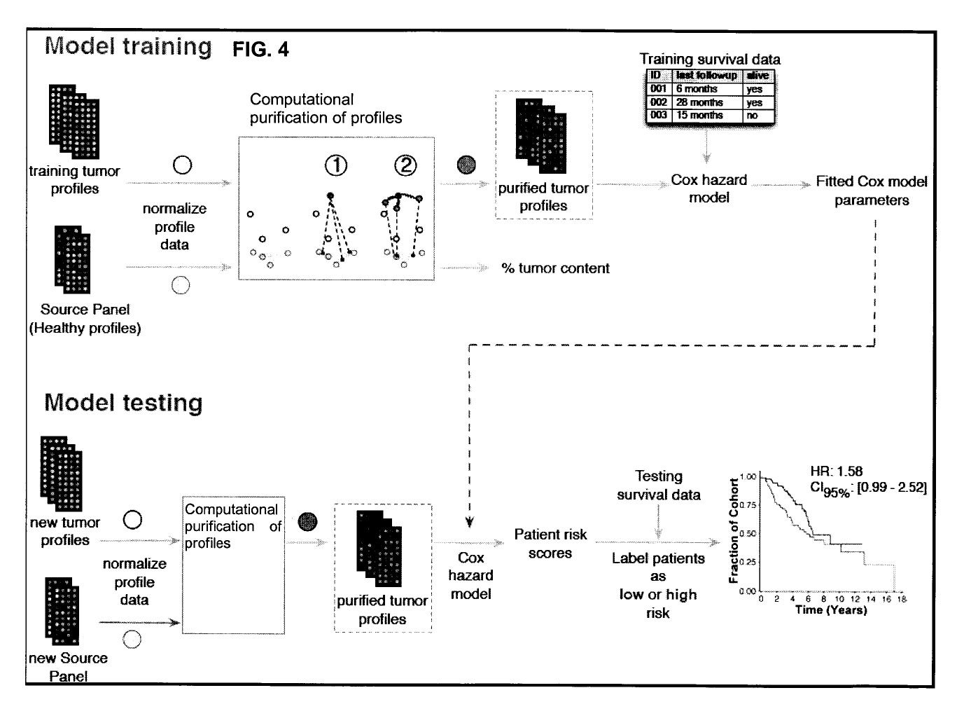

FIG. 4 outlines the strategy used in the example studies for prognostic model development and testing, both for using the original, unpurified expression profiles, as well as the purified profiles (e.g., as obtained using the example method described above). FIG. 4 illustrates an example pipeline for training and testing a gene expression-based prognostic model. A training set of tumor profiles, together with a set of normal profiles, were co-normalized using the RMA algorithm⁵². These profiles were used as input to an example of the disclosed methods to purify the tumor expression profiles, which were then used to construct a Cox Proportional Hazards (CPH) model. A separate test set of tumor profiles were purified in a similar way, then the test set tumors were classified into low and high risk groups based on the trained CPH model. These low and high risk groups are then evaluated for significance of difference in survival distributions of the corresponding patients.

All gene expression measurements were median-centered and unit-standardized within each of the Shedden and Beer cohorts to bring them to the same scale, as others have done¹⁰. Because the Beer and Shedden cohorts were collected on separate arrays (Affymetrix HuGeneFL and U133A, respectively), only the expression levels of the 4755 genes profiled in common were kept.

For each training dataset, the glmnet package (v1.3)⁵⁰ was used to perform 5-fold cross validation of an elastic-net regularized CPH model using the glmnetCV command with default parameters and α=0.1. The identified prognostic model was re-run on the entire training cohort to find the median risk score of the training dataset, to be used as a threshold for identifying low and high risk patients in the test set cohorts. Test set performance was measured by computing the hazard ratio of the binary classification (membership in the high risk group) adjusted for tumor stage.

In the example studies, the strategy for comparing two different sets of patient covariates (i.e., representing purified and unpurified expression profiles, for example) in terms of their relative ability to predict patient prognosis was as follows. First, prognostic models P₁ and P₂ were constructed, using each set of covariates for the same training dataset. Then the procedure described above was used to produce binary classifications c₁ and c₂ of a test dataset based on P₁ and P₂, respectively. The HR of c₁ classifications adjusted for c₂ was calculated by constructing two CPH models: one with covariates c₂ and tumor stage, and the other with covariates c₁, c₂, and tumor stage. A likelihood ratio test (LRT) was calculated to measure the significance of adding c₁ to the CPH model, which would indicate whether model P₁ provided significantly more prognostic information beyond P₂ and tumor stage.

An example of the disclosed method (e.g., as described above) was evaluated with respect to the two main components of deconvolving tumor expression profiles: estimating tumor composition, and estimating the per-tumor cancer expression profile.

First assessed was the ability of the example method to predict the composition of cancerous and healthy tissue of tumor resections collected for gene expression profiling. In the Bhattacharjee dataset of 127 lung adenocarcinomas, two pathologists separately evaluated a subset of 32 samples for cancerous tissue content, and one evaluated all 127 samples.

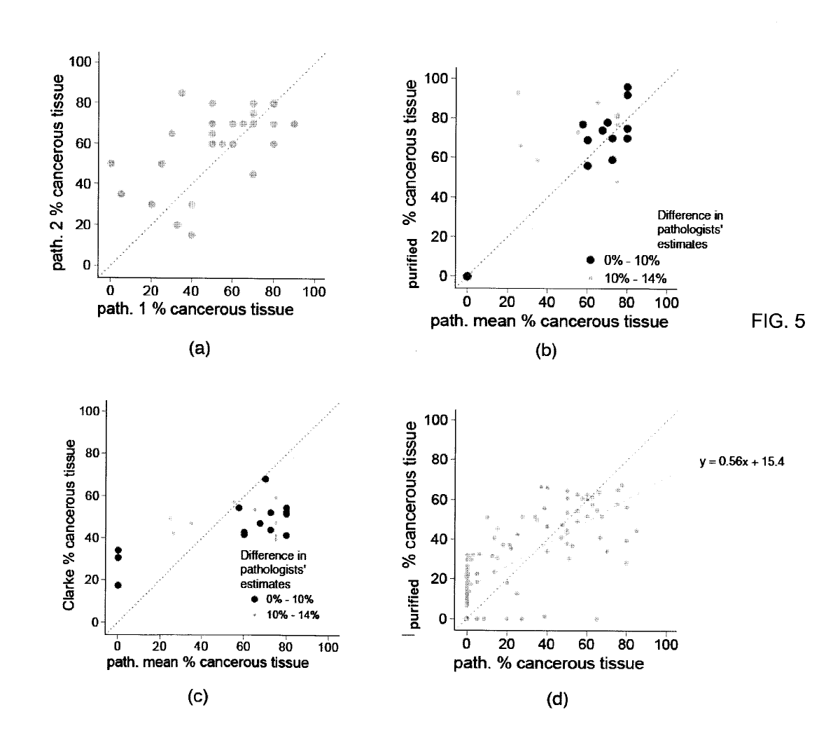

Reference is now made to FIG. 5. FIG. 5 illustrates comparisons of computationally-predicted and pathologist-evaluated tumor composition of lung and prostate tumors. (a) shows a comparison of the estimates of two pathologists on 32 lung tumors in the Bhattacharjee dataset. The blue area indicates where the estimates are within 13.7% of the average pathologist estimate. (b,c) show an example of the disclosed methods (b) and Clarke predictions (c) versus the average of two pathologists on the same 32 lung tumors as (a). The radius of each data point decreases as the difference between the two pathologists' estimates on the tumor sample increases. (d) shows predictions using an example of the disclosed methods versus estimate of a single pathologist on 109 prostate tumors from the Wang dataset. The long dashed line indicates the linear regression model that minimizes the sum of squared errors.

The two pathologists differed by as much as 50% in their estimates of cancerous tissue content, though they are correlated overall (see FIG. 5a, Spearman's ρ=0.59). On the set of 32 commonly-evaluated tumors as well as three blinded control normal samples, the example method estimates showed weak correlation with the average of the pathologists (Spearman's ρ=0.32; p=0.053, rank correlation test³²). The example method correctly predicted 0% cancerous tissue content for the three blinded healthy controls, establishing the ability to detect low percent cancerous tissue content.

The inclusion of tumor samples for which the two pathologists disagreed on content may be partially responsible for the low correlation observed. Therefore, a subset of “confidently assessed tumors” was defined as those for which the pathologists estimates differed by less than one standard deviation of the differences in their estimates (13.7%). On the 20 confidently assessed tumors as well as the three blinded control normal samples, the estimates of the example method had a high, statistically significant correlation (Spearman's ρ=0.51, p=0.013, rank correlation test) with the average of the pathologists. To confirm that the example method predicted confidently assessed tumors more accurately, the correlation between the difference in pathologists' estimates and the difference between the example method and mean pathologist estimate was calculated and found to be high across the 32 commonly evaluated tumors (Spearman's ρ=0:47, p=6:7×10−³, rank correlation test).

Some systematic differences between estimates of tumor content from the example method and the pathologists may reflect differences in how cancerous tissue content was assessed. For example, the example method estimated the proportion of RNA from the tumor sample that is attributable to cancer cells, whereas pathologists typically assess cancerous cell content. Because cancerous cells often contain more RNA than their normal counterparts³¹, estimates of cancerous tissue content by the example method may tend to be larger on average. It was observed that estimates by the example method were 9% higher on average than the mean pathologist estimate of cancerous tissue content (p=0.044, two-sided Mann-Whitney test). Some systematic differences between estimates by the example method and by the pathologists may also arise because pathologists typically assess a slide of the tumor adjacent to the sample processed for molecular analysis, and not the sample itself. These differences may explain the higher correlation between pathologist estimates on all 32 samples (Spearman's ρ=0.59; p=0.00019) compared to that between estimates by the example method and the average prediction made by the pathologists on all 32 tumor samples plus the three controls (Spearman's ρ=0.32; p=0.037). No statistically significant difference was found in any of the clinical characteristics between the highly confident and non-highly confident tumors, including gender, age, censor status, disease status at death, smoking history, tumor size, differentiation, or stage.

The example method includes calculated of estimated tumor composition. To assess the quality of predictions made by the example method, compared to conventional ratio-based methods, Clarke's method⁴² was implemented. FIG. 5c illustrates the Clarke method's predictions on the 32 commonly evaluated tumors. Because no matched normals were available for each tumor sample, the normal profile in the Source Panel with highest correlation was chosen as the “matched” profile. It was found that the correlation of the Clarke method's predictions to the average of the pathologists for both the 20 confidently assessed tumors and blind controls (Spearman's p=0.35; p=0.065) and for all 32 tumors and blind controls (Spearman's ρ=0.28; p=0.06) was less than that of the example method. Furthermore, the range of predicted values is narrower than the true values. Whether this difference was due to a less accurate method or the lack of matched normal samples, these results suggest limited applicability of the conventional ratio-based methods on datasets with no matched normal sample.

It was then assessed whether the example method could be applied to other cancers by comparing the calculated cancerous tissue estimates of 109 prostate tumors²³ versus those of a single pathologist. On this dataset, we found calculated estimates by the example method were highly correlated with those of a pathologist (FIG. 5.3d, Spearman's ρ=0:75, p=1.2×10⁻²⁰) although the calculated estimates diverged from those of the pathologist at the high and low end of the scale. These biases may be inherent in the pathologist's estimation. For example, there were many samples pathologically assessed to have 0% cancerous content classified as tumors in the original study. There may also be differences in the collection protocols between the prostate tumor and normal samples. Unlike the Bhattacharjee dataset where the healthy lung controls and tumors were snap-frozen, some of the healthy prostate controls were collected from corpses and others were collected by biopsy from potentially cancerous prostates. Interestingly, the correlation between the calculated estimates and those of the pathologist on the prostate tumors was higher than that between the two lung pathologists on the Bhattacharjee cohort, which may reflect differences in data quality or difficulty obtaining high quality tumor samples.

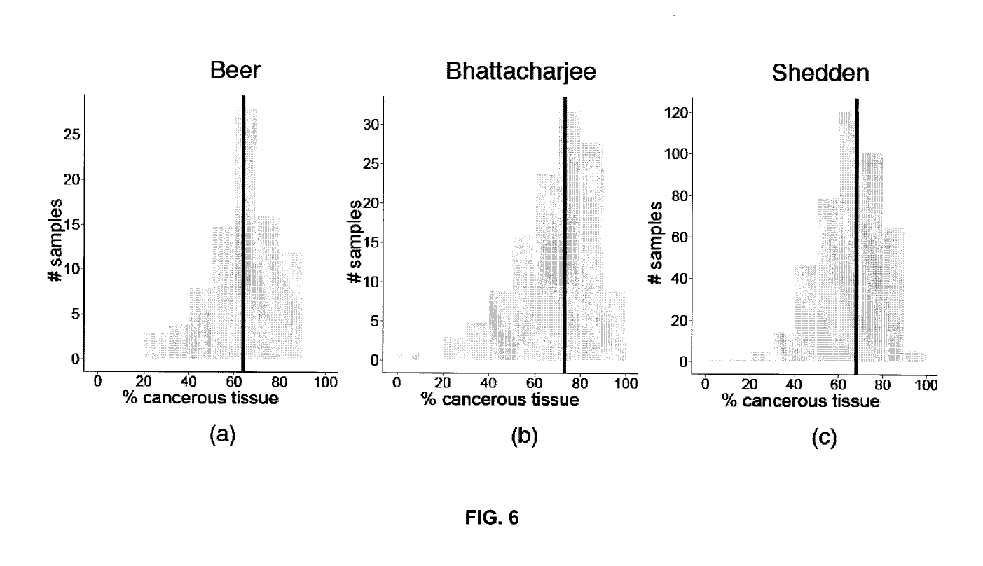

Having established high correlation between the calculated estimates of percentage cancerous tissue by the example method and those by pathologists, the example method was applied to three cohorts of lung adenocarcinoma profiles to evaluate the extent of heterogeneity in tumor samples pre-selected for high cancerous tissue content. This comparison is illustrated in FIG. 6.

FIG. 6 are charts showing the predicted tumor compositions, by the example method, for three lung cancer datasets: (a) the 86 lung tumor samples from the Beer dataset; (b) the 127 lung tumor samples from the Bhattacharjee dataset; and (c) the 443 lung tumor samples from the Shedden dataset. The red line indicates the median estimate in each of the datasets.

The distributions of estimated percentage cancerous tissue were similar for all three datasets, with median percentage cancerous tissue of 65% and standard deviation of 15%. There are a number of samples in each of the three cohorts that were estimated by the example method to have less than 50% cancerous tissue. This suggests that low cancer content tumor samples are a pervasive problem even in high quality gene expression profiling datasets with defined tissue-selection criteria²⁷.

The calculated cancer expression profiles by the example method were also evaluated. Currently, there are no generally-accepted gold standard datasets available with which to compare estimated cancer expression profiles. Conventionally, physical methods for purifying tumor samples before expression profiling may introduce artifacts into the tumor expression profile, limiting their applicability to purify tumor samples. The calculated cancer expression profile estimates were instead verified by quantifying the prediction performance of CPH models that use expression levels as covariates. Under the assumption that changes in cancer expression profiles reflect tumor biology, tumor purification would be expected lead to more accurate prognostic models.

The strategy shown and described in FIG. 4 was used for constructing and testing expression-based prognostic models. This example pipeline was first used to train a model on the Beer cohort of 86 lung tumors, and the resulting signature was tested on the Shedden cohort of 440 patients.

This example pipeline identified an 82-gene signature (unpurified-sig) from the unpurified tumor profiles, and a 110-gene signature (purified-sig) from the purified tumor profiles obtained by the example method. The signatures were found to have a statistically significant overlap of 48 genes (p=2.0×10⁻⁶¹, Fishers exact test), all of which were found to be in agreement about whether their expression increases or decreases the risk of death.

TABLE 1
110-gene signature

| EntrezID | hgnc_symbol | Value |
|---|---|---|
| 13 | AADAC | 0.0009902 |
| 133 | ADM | 0.04235681 |
| 221 | ALDH3B1 | 0.01443276 |
| 222 | ALDH3B2 | 0.0565646 |
| 240 | ALOX5 | 0.00075234 |
| 412 | STS | −0.0029022 |
| 490 | ATP2B1 | 0.05563218 |
| 493 | ATP2B4 | −0.017198 |
| 573 | BAG1 | 0.00484405 |
| 638 | BIK | 0.04392956 |
| 653 | BMP5 | −0.0004976 |
| 760 | CA2 | 0.00138232 |
| 926 | CD8B | −0.0276705 |
| 953 | ENTPD1 | −0.0063038 |
| 1040 | CDS1 | 0.00755513 |
| 1316 | KLF6 | 0.01266181 |
| 1396 | CRIP1 | 0.01368329 |
| 1475 | CSTA | 0.01119006 |
| 1476 | CSTB | 0.00184468 |
| 1511 | CTSG | 0.00113125 |
| 1591 | CYP24A1 | 0.02124181 |
| 1672 | DEFB1 | 0.00112727 |
| 1728 | NQO1 | 0.02583022 |
| 2013 | EMP2 | 0.02376101 |
| 2033 | EP300 | −0.0129557 |
| 2043 | EPHA4 | −0.0055625 |
| 2064 | ERBB2 | 0.00812535 |
| 2172 | FABP6 | 0.01048012 |
| 2243 | FGA | 0.00319059 |
| 2250 | FGF5 | −0.0014834 |
| 2475 | MTOR | −9.23E−05 |
| 2517 | FUCA1 | −0.0137826 |
| 2525 | FUT3 | 0.00042799 |
| 2528 | FUT6 | 0.03319553 |
| 2634 | GBP2 | 0.01259466 |
| 2702 | GJA5 | −0.0320431 |
| 2820 | GPD2 | 0.00136854 |
| 2903 | GRIN2A | −0.0123436 |
| 2950 | GSTP1 | 0.00052644 |
| 2963 | GTF2F2 | 0.00951096 |
| 3241 | HPCAL1 | 0.04438766 |
| 3249 | HPN | −0.0197377 |
| 3373 | HYAL1 | 0.00179327 |
| 3384 | ICAM2 | −0.0191088 |
| 3491 | CYR61 | −0.0116416 |
| 3553 | IL1B | 0.01293196 |
| 3635 | INPP5D | −0.0205074 |
| 3641 | INSL4 | 0.02781837 |
| 3725 | JUN | −0.0138491 |
| 3855 | KRT7 | 0.00320829 |
| 3985 | LIMK2 | 0.00606675 |
| 4026 | LPP | 0.01875237 |
| 4239 | MFAP4 | −0.0007611 |
| 4325 | MMP16 | 0.02507062 |
| 4331 | MNAT1 | 0.00554666 |
| 4363 | ABCC1 | 0.03326127 |
| 4761 | NEUROD2 | 0.01844493 |
| 4860 | PNP | 0.00605736 |
| 4938 | OAS1 | 0.00470907 |
| 5031 | P2RY6 | 0.00128542 |
| 5054 | SERPINE1 | 0.00664346 |
| 5097 | PCDH1 | 0.00373457 |
| 5106 | PCK2 | 0.00254578 |
| 5121 | PCP4 | −0.012193 |
| 5122 | PCSK1 | −0.0060531 |
| 5168 | ENPP2 | −0.0120135 |
| 5557 | PRIM1 | 0.00354172 |
| 5629 | PROX1 | −0.011664 |
| 5754 | PTK7 | −0.0101081 |
| 5781 | PTPN11 | 0.06020387 |
| 5799 | PTPRN2 | −0.0030489 |
| 6038 | RNASE4 | 0.00664291 |
| 6197 | RPS6KA3 | −0.0097249 |
| 6240 | RRM1 | 0.0141103 |
| 6279 | S100A8 | 0.04409627 |
| 6286 | S100P | 0.03278381 |
| 6402 | SELL | −0.0257119 |
| 6657 | SOX2 | 0.00305831 |
| 6689 | SPIB | −0.0210373 |
| 6699 | SPRR1B | 0.03445705 |
| 6781 | STC1 | 0.01892837 |
| 7088 | TLE1 | 0.00229366 |
| 7169 | TPM2 | 0.00186461 |
| 7204 | TRIO | −0.0070375 |
| 7347 | UCHL3 | 0.02883789 |
| 7422 | VEGFA | 0.02537028 |
| 7424 | VEGFC | 0.01847294 |
| 7474 | WNT5A | −0.008586 |
| 7480 | WNT10B | 0.01159408 |
| 7832 | BTG2 | −0.0065286 |
| 7941 | PLA2G7 | −0.007226 |
| 8404 | SPARCL1 | 0.02114923 |
| 9518 | GDF15 | −0.0119243 |
| 9590 | AKAP12 | 0.02948185 |
| 9772 | KIAA0195 | −0.0310234 |
| 10280 | SIGMAR1 | 0.00121199 |
| 10554 | AGPAT1 | −0.0089634 |
| 10994 | ILVBL | 0.00673689 |
| 11184 | MAP4K1 | −0.0140421 |
| 23180 | RFTN1 | −0.0373029 |
| 23237 | ARC | 0.02857285 |
| 23646 | PLD3 | −0.0181966 |
| 28395 | IGHV4-34 | −0.0206523 |
| 29896 | TRA2A | −0.0146942 |
| 54498 | SMOX | 0.00409607 |
| 57326 | PBXIP1 | −0.0380376 |
| 89927 | C16orf45 | −0.0151867 |
| 116138 | KLHDC3 | −0.0004354 |
| 171558 | PTCRA | 0.00298614 |
| 100131160 | RPL39P20 | 0.0077605 |

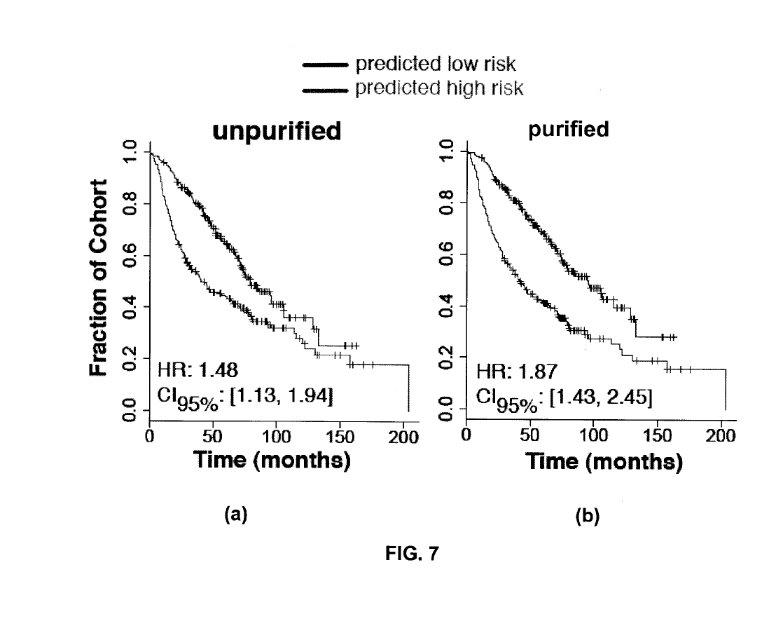

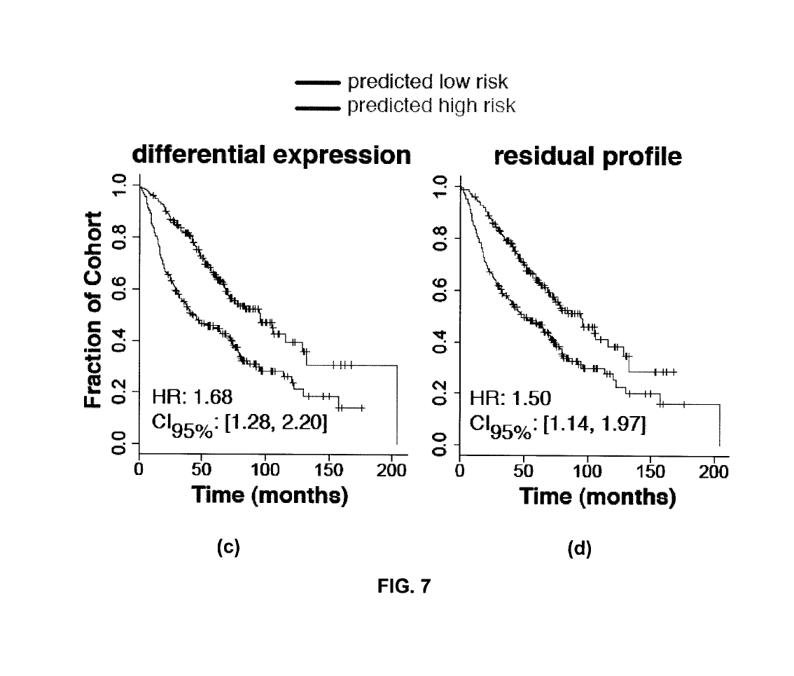

Both purified-sig and unpurified-sig were tested by classifying each of the 440 patients from the four cohorts in the Shedden dataset (three patients with missing annotation were excluded due to missing clinical data). FIG. 7 reports the performance of purified-sig and unpurified-sig across all 440 patients, adjusted for stage.

FIG. 7a-7d illustrate test set performance of prognostic models trained on the Beer dataset and tested on the Shedden dataset, with or without using various computational purification strategies. Illustrated are Kaplan-Meier survival curves of the predicted low (blue) and high (red) risk groups, based on prognostic models trained on either purified profiles (using the modified Wang et al.⁵¹ approach described below or the example method) or the original unpurified profiles. The graphs report the Stage-adjusted hazard ratio (HR) of the high risk relative to the low risk group, and the associated 95% confidence interval. The Wald test p-value indicates the significance of differential hazard between the two groups (i.e. testing the null hypothesis that hazard ratio (HR)=1).

Both the purified-sig (HR=1:87, p=4.7×10⁻⁶, Wald test) and unpurified-sig (HR=1.48, p=0:004, Wald test) were predictive of patient risk of death. However, the purified-sig was found to provide significantly more prognostic information in addition to what unpurified-sig provided (p=2.7×10⁻⁴, LRT).

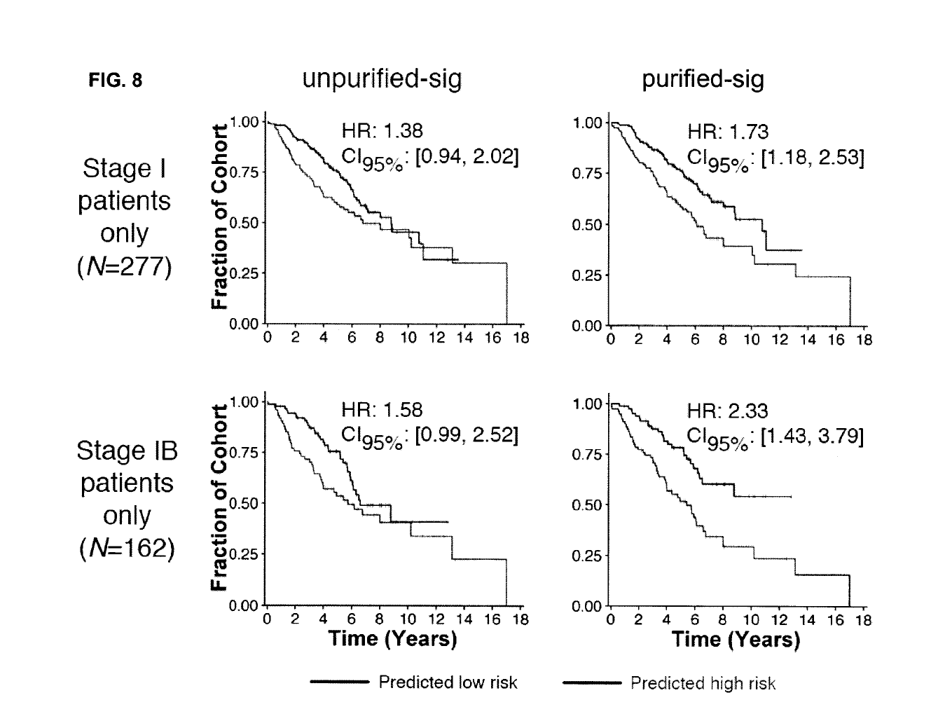

To investigate the source of the improvement in model performance of purified-sig over unpurified-sig, the 70 patients for which the two signatures disagreed in their classification of these patients into the risk groups were identified. These 70 differentially classified patients are significantly enriched for Stage IB tumors at the time of expression profiling (p=0.011, Bonferroni-corrected hypergeometric test). The analysis of the KM survival curves was restricted to the Stage I and Stage IB patients only. When the hazard ratio calculation was restricted to samples of Stage IB tumors, purified-sig was found to provide an even greater benefit to prognostic modeling (FIG. 8, HR_{purified-sig}=2.33; HR_{unpurified-sig}=1.58, p=3.48×10⁻³, LRT).

FIG. 8 shows the test set performance of prognostic model trained on the Beer dataset and tested on Stage I or Stage IB only patients of the Shedden dataset, with or without using the example method. These KM survival curves are similar to those in FIG. 7, but focus on either the subgroup of 277 Stage I patients, or the subgroup of 162 Stage IB patients.

This performance improvement may be useful because early stage tumors may be considered the clinically most important population for classification³⁵. These improvements may be attributable to computational purification because the 277 Stage I tumors in this cohort have significantly lower median predicted cancer content than the 164 tumors of later Stages (66.7% versus 69.4%, p=2.2×10-3, Wilcoxon rank sum test). Similar improvement is seen for Stage I tumors only (FIG. 5.6, HR_{purified-sig}=1.73; HR_{unpurified-sig}=1.38, p=3.53×10⁻³, LRT).

The disclosed methods and systems may be used to model per-tumor cancer expression profiles and test the resulting improvement in prognosis prediction. Conventionally, genome-wide biomarker profiles can also be computed by calculating per-tumor differential expression profiles (without computing per-tumor cancer profiles). Wang et al.⁵¹ proposed to adjust each individual tumor expression profile t_{d} to produce a differential expression profile t̅_{d} as follows:

$$\overline{{t}_{d}} = {t}_{d} - {\sum }_{k = 1}^{K} {β}_{k} {θ}_{d , k}$$

where βₖ represents the expression profiles of the K known cell types composing sample d, and both K and all βₖ are assumed to be known. Wang et al. proposed a method for estimating the mixing proportions θ_{d,k}, and showed that these new profiles t̅_{d} can be used to identify differentially expressed genes that do not arise because of differences between sample mixing proportions. However, Wang's method cannot be applied here because the cancer profile is unknown.

In order to compare the example method to the Wang method, the Wang approach was adapted by using the normal profiles in the Source Panel and the average cancer profile estimates calculated by the example method as the component profiles βₖ. The mixing proportion estimates calculated by the example method were used in conjunction with these component profiles to compute differential expression profiles td using the above equation. These t̅_{d} instead of the purified expression profiles as t̅_{d} covariates to the CPH model trained according to the method shown and described in FIG. 4.

The predictive performances of prognostic models constructed using either the conventional differential expression approach or the conventional residual profiles approach were compared, using the Beer cohort as a training dataset and the Shedden cohorts as a testing dataset. FIG. 7 shows that both the differential expression and residual profile approach were found to perform worse than the example method.

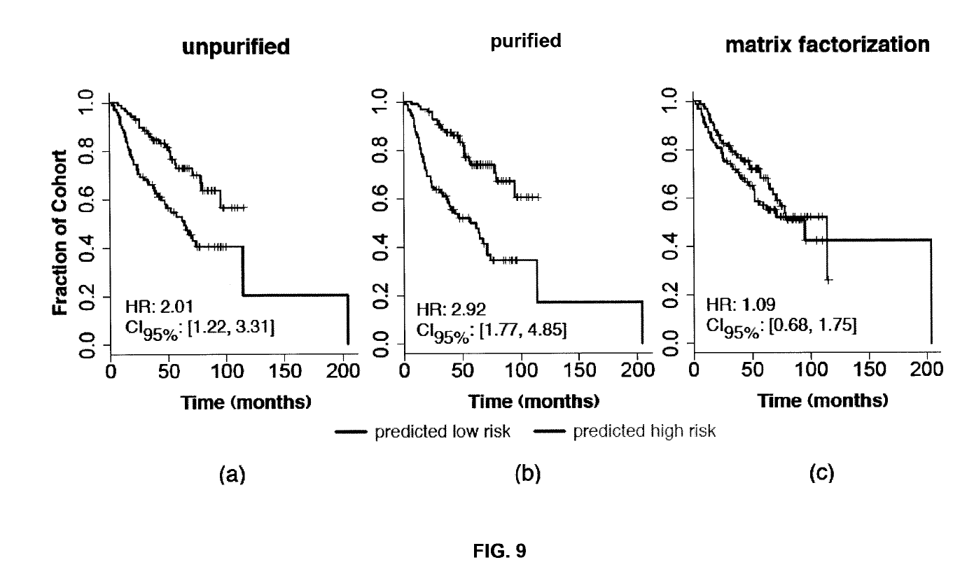

The performance of the calculated gene expression profiles were evaluated in their ability to predict prognosis using the Shedden HLM and MI cohorts for training, and the DFCI and MSKCC cohorts for testing. FIG. 9 illustrates the performance of these prognostic models.

FIG. 9 shows the test set performance of prognostic models trained on the HLM and MI cohorts and tested on the DFCI and MSKCC cohorts of the Shedden dataset. These models were based on either the unpurified expression profiles, the purified expression profiles calculated by the example method, or the 50 mixing proportion weights estimated by the example method (a matrix factorization-like approach to deconvolution).

The unpurified profile-based method was found suitable for prediction of survival, achieving a 95% confidence interval greater than 1. The model based on the example method achieved a significantly higher hazard ratio than the unpurified based model (HR_{purified}=2.92 versus HR_{unpurified}=2.01, p=1.2×10⁻³, LRT). The predictive performance of CPH models was also tested based on the mixing proportions of the 49 normal profiles of the Source Panel and the proportion due to cancer, because these were the only covariates that the shared profile method could produce for input into a prognostic model. The mixing proportions were found to be not predictive of prognosis (HR=1.09, p=0.72, Wald test). This may be because the mixing proportions can be thought of as the closest projection of the tumor profiles to the convex hull of the shared cell types as in FIG. 3a. Because of the reduced dimensionality of the mixing proportions relative to the expression profiles (11911 genes versus 50 mixing proportions), the relative distances between tumor samples after projection may be noisy and thus less informative of prognosis.

To investigate whether purification using the example method makes any global changes to the tumor expression profiles, tumor expression profiles t_{d} were compared to their respective calculated cancer expression profiles γ^{d}.

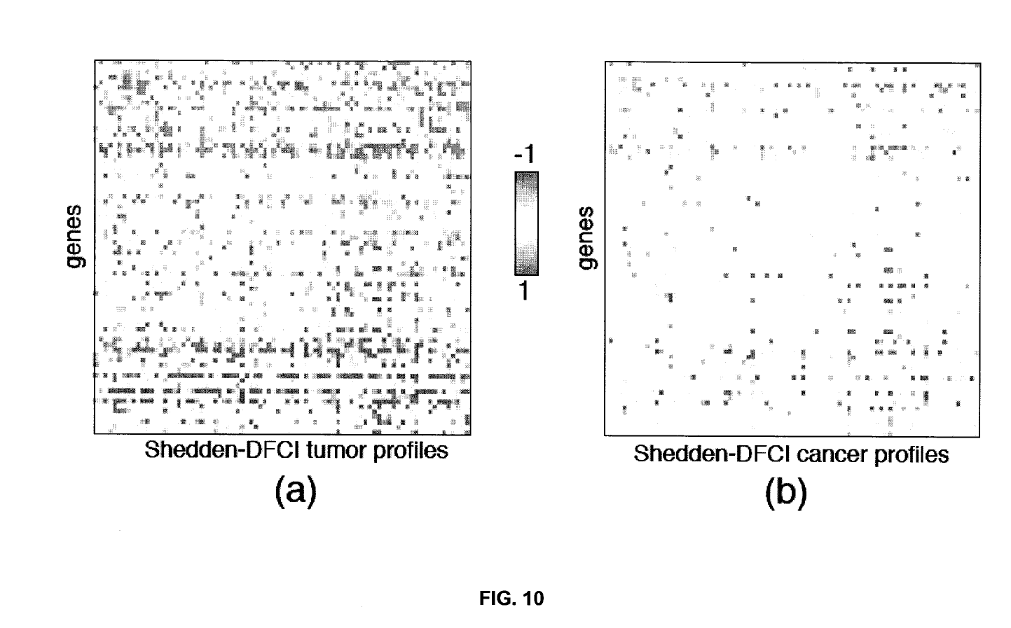

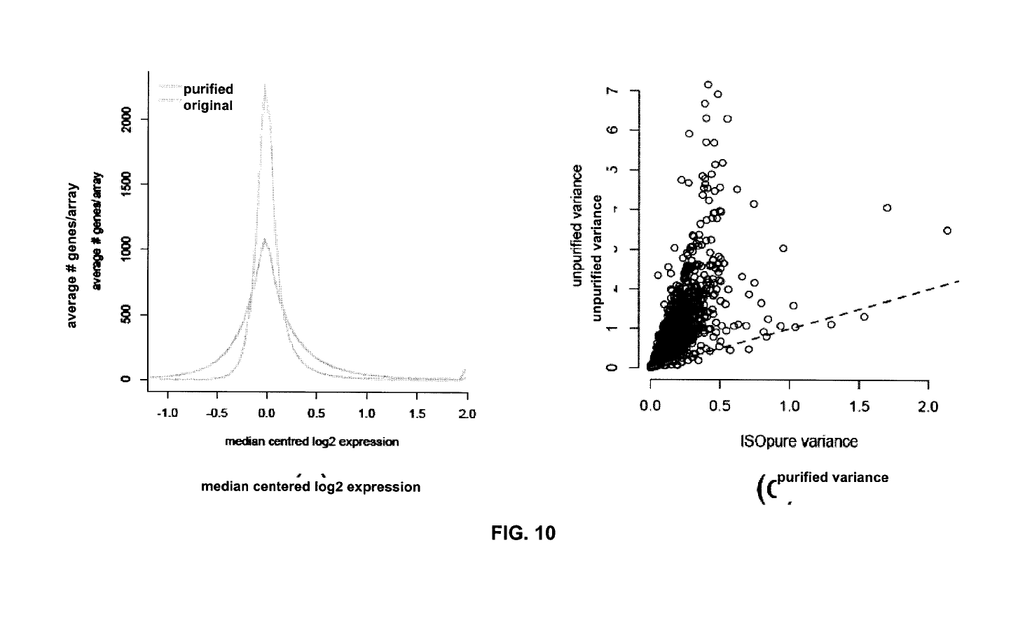

FIG. 10 illustrates gene expression profiles before and after purification using the example method. (a) shows median subtracted expression levels of the unpurified DFCI cohort of 82 patients from the Shedden dataset, for a random subset of 110 genes. (b) shows median subtracted purified cancer profiles of the same patients and gene subset as in (a). (c) shows the distribution of median-centered expression levels of the 440 patients of the Shedden cohorts and 11911 expression levels, for both the purified cancer profiles and original unpurified tumor profiles. (d) shows the variance of each of 11911 genes, across all four Shedden cohorts, in the tumor versus cancer expression profiles. The red dashed line is the y=x line.

FIGS. 10a and 10b illustrate the expression of a random selection of 110 genes profiled in the 82 patients of the DFCI cohort from the Shedden dataset. Purification using the example method leads to a visible reduction in the variability of gene expression across the cohort. This trend was verified across all genes and all patients from the Shedden dataset in FIG. 10c, which shows that the unpurified profiles have a wider distribution of median centered, log₂ expression levels. Overall, use of the example method was found to lead to a reduction in the variability of expression levels, with a median decrease of variance of 0.10 (p<2.2×10⁻¹⁶, Wilcoxon signed rank test). 99.7% of genes exhibit larger variance in the tumor profiles than their corresponding cancer profiles, as seen in FIG. 10d.

The example method uses a Source Panel of normal profiles to model gene expression patterns that can be attributed to normal (or healthy) cells. There are many types of normal cells that can contaminate a tumor sample (healthy stroma, healthy epithelial, immune cells) and so it may be useful to have a wide range of normal samples in the Source Panel. It is of interest to estimate the minimum number of normal profiles needed to deconvolve tumor samples to facilitate identification of archival datasets that may benefit from the disclosed methods and systems, as well as help design better guidelines for selecting the appropriate number of normal samples to profile in future cancer expression studies.

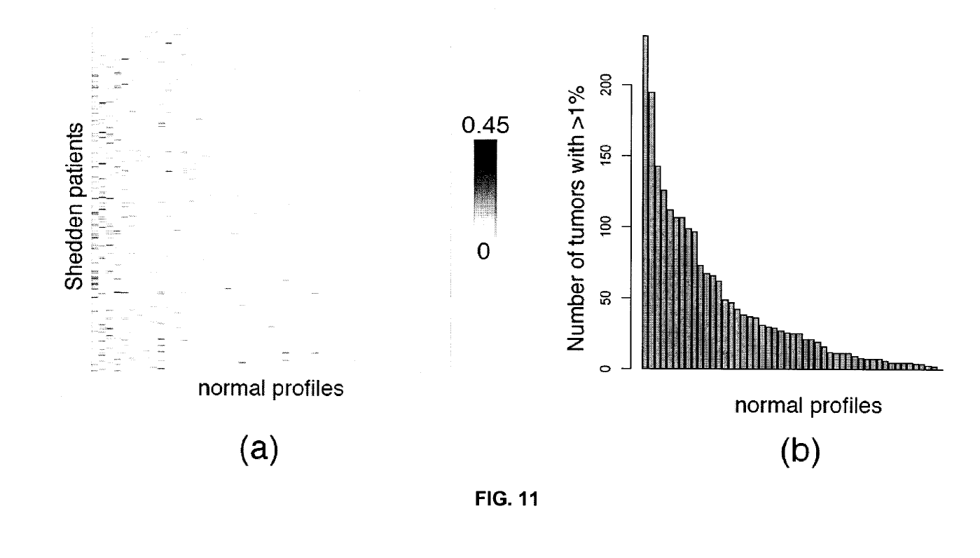

It was investigated whether specific components of the Source Panel were being used more often than others to deconvolve tumor samples. The deconvolution of the 443 samples in the Shedden dataset using 49 normal samples provided both the largest Source Panel and the largest set of tumor samples to study. FIG. 11a illustrates the MAP estimates of the hidden variables θ_{d,k} over all 443 tumor samples d and normal components kε {1, . . . , 49}. Shown are the fractions of each of the 443 samples of the Shedden cohort attributed to each of the 49 normal samples used to deconvolve them. Rows are tumor samples and columns are the normal profiles. Columns are ordered left to right in decreasing amount of RNA contributed over all tumor samples (column sum). FIG. 11b shows the number of tumor samples in which each normal profile was estimated to explain at least 1% of the expression profile. Shown is a bar plot of the number of tumor samples in which each normal sample was estimated to contribute at least 1% of the RNA in the tumor sample.

Some normal profiles were found to be used much more frequently than others. For example, 71% of the total normal signal across all 443 tumor samples was found to be captured by ten of the normal profiles, while 90% of the total normal signal across all 443 tumor samples was found to be captured by 20 normal profiles. This suggests that not all 49 normal profiles may be needed to achieve similar predictive performance as the entire set of 49 normal samples.

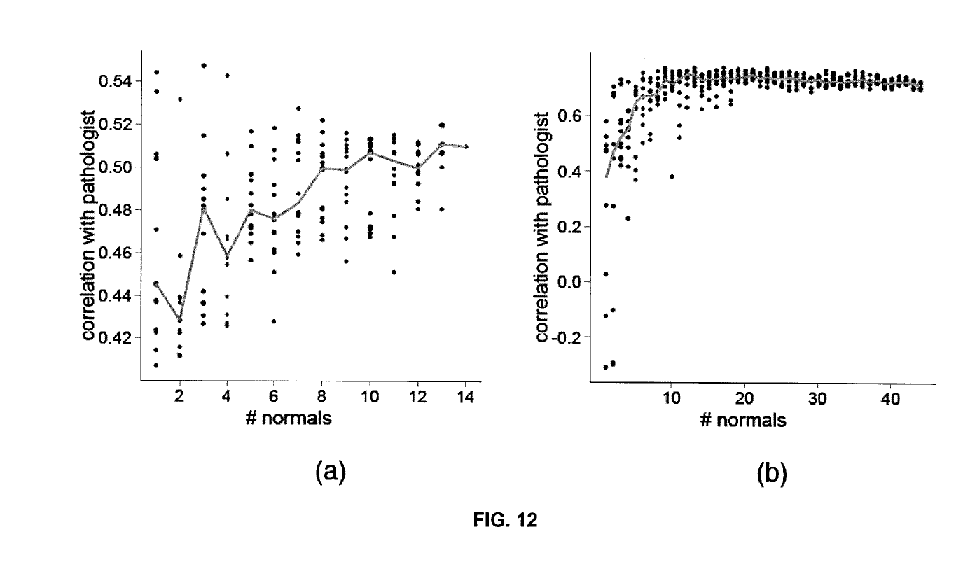

The effect of the number of normal profiles on the correlation of calculated tumor composition by the example with pathologists' assessment was also evaluated, shown in FIG. 12.

FIG. 12 shows the Spearman correlation of percentage cancerous tissue calculated using the example method with the pathologist estimate, as a function of the number of normal profiles in the Source Panel. The red line indicates the median correlation for random subsets of normal profiles used to populate the Source Panel. (a) shows the correlation of calculated predictions against the average of the two pathologists on the 23 confidently-assessed tumors and healthy controls from the Bhattacharjee dataset. Source Panel sizes of 1 to 14 were evaluated, as there were only 14 normal samples profiled in the study (three were treated as blind tumor samples). For each size of Source Panel, 14 random sets were evaluated. (b) shows the correlation on the 109 prostate tumor samples from the Wang dataset. For each size of Source Panel (1 to 44), 10 random sets were evaluated.

To determine the number of normal samples at which improvement in correlation was not significant, the improvement in correlation for a Source Panel of size x was determined by comparing the distribution of correlations for Source Panels of size [x−2,x−1] against the distribution of correlations for Source Panels of size [x+1; x+2]. This sliding window calculation was used to help overcome the low statistical power of testing only 10 samples for each Source Panel size. Ten normal profiles in the Source Panel was found to be the first size for which improvement in correlation on the prostate dataset was not significant, where significance is defined as a Wilcoxon rank sum test p-value of 0.05 or smaller.

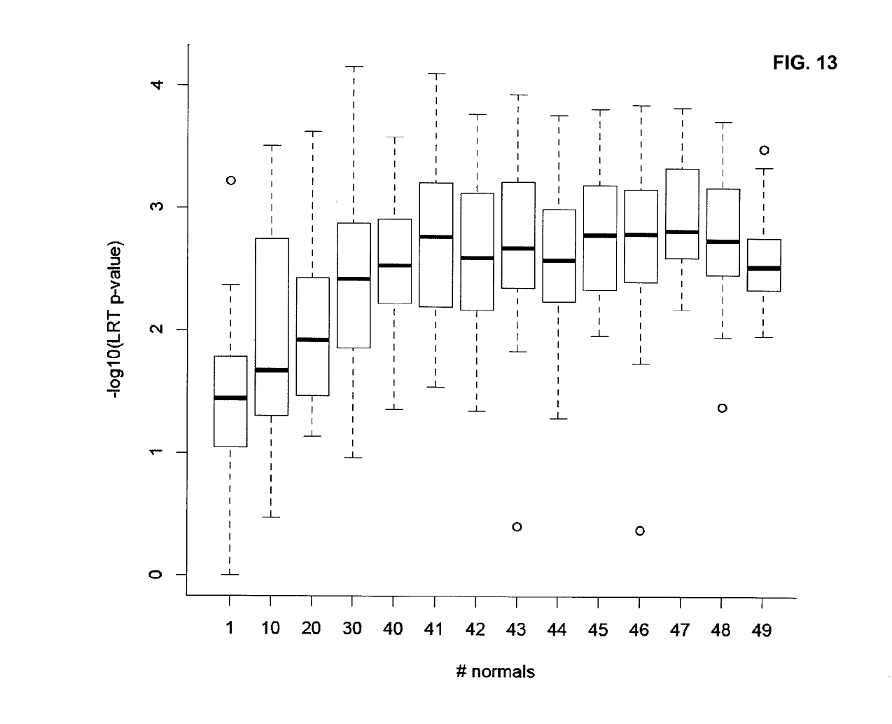

The effect of the size of Source Panel on the predictive performance of the purified profiles was also determined. FIG. 13 illustrates the test set performance of the example method as a function of Source Panel size, using the Shedden cohort when using the Beer cohort as a training dataset. The pipeline method shown in FIG. 4 was used to train and test a prognostic signature, using the Beer and Shedden datasets as training and testing cohorts, respectively. The full Beer dataset contains 10 normal profiles and the full Directors Challenge dataset contains 49 normal profiles. The x-axis indicates the maximum number of normal samples available for use in the example method for purifying the tumor samples from the training and testing cohorts. Each box shows the distribution of performance of 49 CPH models, each trained with cancer profiles that were purified, by the example method, using a Source Panel of randomly selected normal profiles. Because the training dataset only had 10 normal profiles, after x=10 all 10 normal samples were used for purification of the training cohort.

Pairwise Wilcoxon rank sum tests were calculated between each distribution of −log 10 (LRT p-values) observed for a given size of Source Panel and the distribution of the next smallest Source Panel size. The last significant improvement in performance from incrementing the size of the Source Panel was found to be at 30 normal samples, suggesting that while fewer samples may be used to get a robust estimate of the tumor composition, we a larger Source Panel may be used to obtain an accurate cancer expression profile. A default panel size may be at least 30 normal samples, however more or less samples may be used in the Source Panel. The suitable number of normal samples to include in the Source Panel may be dependent on factors such as the heterogeneity of the sample and source populations. For example, if the sample and source populations have a certain level of homogeneity (e.g., all are derived from a simple organ such as the liver, or all are derived from patients of a single ethnicity or sex) then the size of the panel may be smaller. In another example, if the sample and source populations are more heterogeneous or more complex (e.g., derived from the brain), then a larger Source Panel may be required.

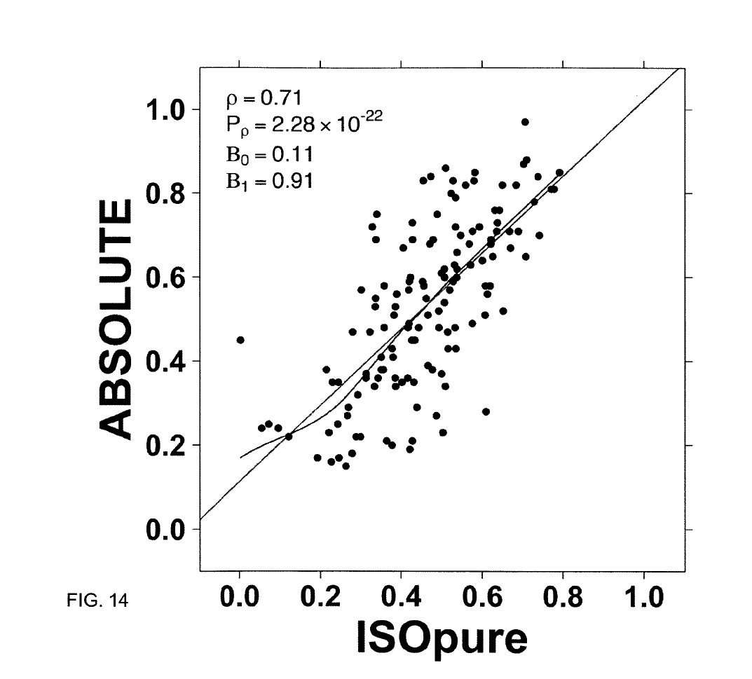

This approach can be used on data generated from RNA-Sequencing studies (e.g. next-generation sequencing of RNA directly). Referring to FIG. 14, we used provisional RNA-Seq data from the prostate cancer sub-project of The Cancer Genome Atlas (TCGA) and generated predictions of tumour cellularity using the disclosed methods and systems. Measurements of tumour-cellularity based on RNA-Seq measurements closely match those derived using DNA microarray data (Spearman's correlation coefficient of 0.71).

Discussion and Variations

Tumor heterogeneity may have an impact on predictive models of lung cancer patient risk of death. Purification of expression profiles by the disclosed methods and systems may help to improve predictive performance, for example as found in the example studies on a 440-patient testing cohort that has previously been intensively investigated with a number of algorithms for training CPH models.

The disclosed methods and systems may also be useful for evaluating Stage I patients alone. This group of patients has a clinical need for good prognostic models. Stage I tumors were predicted, by an example of the disclosed methods, to have lower percentage cancerous tissue than later Stage tumors, which may result in purified profiles, obtained using the disclosed methods and systems, predicting Stage I patient risk better than unpurified profiles. Similar performance gains may be expected for other low cancer content samples.

Purification using the disclosed methods and systems was also found, in example studies, to lead to lower inter-tumor variability in gene expression. Combined with the finding calculated estimates of tumor composition, by an example of the disclosed methods, correlate with those of pathologists, this suggests that the disclosed methods and systems may also remove intertumor variation due to normal cell contamination.

Tumor expression profile purification may help to increase the number of patients that can benefit from expression-based prognostic models. Excluding tumor samples with too little cancerous tissue content for molecular analysis may currently restrict the use of prognostic models to that subset of patients whose tumors pass the content threshold. Tumor samples selected for gene expression analysis may vary widely in their cancerous tissue content, so a large number of patients may stand to gain from improved sample purification.

The disclosed methods and systems may also play a supplemental role to pathological evaluation of tumors by providing an independent assessment of cancerous RNA content. For example, in both lung and prostate analyses, example studies found that calculated estimates of percentage cancerous tissue, by an example of the disclosed methods, were well-correlated with those of pathologists, so the disclosed methods and systems may provide a computationally assessed second opinion on tumor content.

The disclosed methods and systems may be used where the healthy tissue profiles are collected using the same or different protocol as the tumor samples.

Computational purification of expression profiles using the disclosed methods and systems may help to avoid or decrease the cost, error, time, and any possible impact on RNA levels due to physical purification. By using the disclosed methods and systems for purification, prognostic predictions may be made relatively quickly after molecular profiling and/or at reduced or minimal marginal cost.

The disclosed methods and systems may add value to existing prognostic model studies because they may be applied retrospectively to the large numbers of archival datasets for which pathologist assessments are not available and/or where the physical samples have been degraded or consumed.

Use of the disclosed methods and systems may help in overcoming one or more of the following limits: the requirement that the mixing weights (tumor composition) be known or assumed to be known, the requirement that all tumor samples share the same cell types or are assumed to share the same cell types, and the requirement that matched normal samples are available or are assumed to be available. Conventional procedures may require one or more of these requirements, which may limit their utility for computational tumor profile purification.

Based on the example studies comparing an example of the disclosed methods to other expression deconvolution methods, the example method was found to lead to an improvement in prediction of patient prognosis not found in the other methods.

It may be useful to determine a minimum number of normal profiles needed to populate the Source Panel in order to achieve satisfactory purification of a given set of samples. The disclosed methods and systems use the Source Panel to account for expression patterns from contaminating cells (e.g., healthy tissue or non-tumor tissue). Because there are multiple, distinct normal cell types, the normal component of a tumor sample may be a mixture of normal cell types. Empirical results may be used to estimate the minimum size of the Source Panel. In some examples, to estimate tumor composition, 10 to 20 normal profiles may be sufficient, while in some examples, to estimate an accurate cancer expression profile 30 normal profiles may be sufficient. The size of the Source Panel needed to achieve best deconvolution results may vary with respect to cancer type, collection protocol, and/or size of the patient cohort, among other factors, and may be determined empirically.

The disclosed methods and systems may be used to determine a single cancer profile per tumor sample, and may help to address inter-tumor heterogeneity that may arise from differences in the normal cells present in the tumor samples. However, individual tumors can be composed of multiple subpopulations of cancer cells, each with distinct functional properties and diverse gene expression. The per-tumor cancer expression profile determined using the disclosed methods and systems may be the average expression over all cells that are not represented in the normal samples from the Source Panel. This may include the multiple cancer populations as well as “normal” cells that are affected by neighboring cancer cells, such as cancer stroma cells.

There are shared profile methods that may be used to estimate multiple sub-populations of cancer cells within tumors, by assuming that all tumor samples contain the same subpopulations of cancer cells. However, one of the drawbacks of these approaches is that they cannot identify which of their estimated expression profiles are cancer subpopulations and which are normal cell populations. The disclosed methods and systems may be used to complement these efforts by removing healthy tissue contamination from the tumor expression profiles before input into these algorithms. All estimated expression profiles from these methods may then correspond to cancerous cell populations.

The disclosed methods and systems may be fully automated and unbiased (e.g., not reliant on individual pathologists' abilities), and may use as input only tumor samples, healthy tissue samples, and associated clinical data (e.g. survival time or tumor progression indicators, among others). The disclosed methods and systems may complement any prognostic model development method for any solid tumor type, including those focusing on proteomic, copy-number variation, or next-generation genome-sequencing data.

The disclosed methods and systems have been described as first calculating an estimated average cancer profile using all input tumor and using the average cancer profile as a regularizer to calculate the percentage tumor composition of each tumor profile. For cancers with several clinically and molecularly-distinct subtypes, such as breast cancer, a single average cancer profile may not well approximate the individual cancer profiles and thus may not be an appropriate regularizer.

The disclosed methods and systems may be modified, using suitable techniques and calculations, to implement either a finite or infinite mixture model to allow multiple average cancer profiles to be calculated, and to allow the use of more than one average profile to be representative of all cancer profiles. Inferring as many average profiles as there are tumor samples may be the same as trying to determine parameters of each tumor sample independently. Analysis to define a procedure for estimating the optimal number of average profiles to infer may allow the use of more than one average cancer profile.

The embodiments of the present disclosure described above are intended to be examples only. Alterations, modifications and variations to the disclosure may be made without departing from the intended scope of the present disclosure. In particular, selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

### REFERENCES

1. Liotta, L. & Petricoin, E. Molecular profiling of human cancer. Nat Rev Genet 1, 48-56 (2000).
2. Herbst, R. S., Heymach, J. V. & Lippman, S. M. Lung cancer. N Engl J Med 359, 1367-1380 (2008).
3. Golub, T. R. et al. Molecular classification of cancer: class discovery and class prediction by gene expression monitoring. Science 286, 531-537 (1999).
4. Ishibashi, Y. et al. Profiling gene expression ratios of paired cancerous and normal tissue predicts relapse of esophageal squamous cell carcinoma. Cancer Res 63, 5159-5164 (2003).
5. Korkola, J. E. et al. Differentiation of lobular versus ductal breast carcinomas by expression microarray analysis. Cancer Res 63, 7167-7175 (2003).
6. Mariadason, J. M. et al. Gene expression profiling-based prediction of response of colon carcinoma cells to 5-fluorouracil and camptothecin. Cancer Res 63, 8791-8812 (2003).
7. Boutros, P. C. et al. Prognostic gene signatures for non-small-cell lung cancer. Proc Natl Acad Sci USA 106, 2824-2828 (2009).
8. Chibon, F. et al. Validated prediction of clinical outcome in sarcomas and multiple types of cancer on the basis of a gene expression signature related to genome complexity. Nat Med 16, 781-787 (2010).
9. Korkola, J. E. et al. Identification and validation of a gene expression signature that predicts outcome in adult men with germ cell tumors. J Clin Oncol 27, 5240-5247 (2009).
10. Lau, S. K. et al. Three-gene prognostic classifier for early-stage non small-cell lung cancer. J Clin Oncol 25, 5562-5569 (2007).
11. van't Veer, L. J. et al. Gene expression profiling predicts clinical outcome of breast cancer. Nature 415, 530-536 (2002).
12. Vermeulen, J. et al. Predicting outcomes for children with neuroblastoma using a multigene-expression signature: a retrospective SIOPEN/COG/GPOH study. Lancet Oncol 10, 663-671 (2009).
13. Zhu, C. Q. et al. Prognostic and predictive gene signature for adjuvant chemotherapy in resected non-small-cell lung cancer. J Clin Oncol 28, 4417-4424 (2010).
14. Khambata-Ford, S. et al. Expression of epiregulin and amphiregulin and K-ras mutation status predict disease control in metastatic colorectal cancer patients treated with cetuximab. J Clin Oncol 25, 3230-3237 (2007).
15. Quon, G. & Morris, Q. ISOLATE: a computational strategy for identifying the primary origin of cancers using high-throughput sequencing. Bioinformatics 25, 2882-2889 (2009).
16. Varadhachary, G. R. et al. Molecular profiling of carcinoma of unknown primary and correlation with clinical evaluation. J Clin Oncol 26, 4442-4448 (2008).
17. Bueno-de-Mesquita, J. M. et al. Use of 70-gene signature to predict prognosis of patients with node-negative breast cancer: a prospective community-based feasibility study (RASTER). Lancet Oncol 8, 1079-1087 (2007).
18. Glas, A. M. et al. Converting a breast cancer microarray signature into a high-throughput diagnostic test. BMC Genomics 7, 278 (2006).
19. Monzon, F. A. et al. Multicenter validation of a 1,550-gene expression profile for identification of tumor tissue of origin. J Clin Oncol 27, 2503-2508 (2009).
20. Trial watch: Adaptive BATTLE trial uses biomarkers to guide lung cancer treatment. Nat Rev Drug Discov 9, 423 (2010).
21. Dennis, J. L. et al. Markers of adenocarcinoma characteristic of the site of origin: development of a diagnostic algorithm. Clin Cancer Res 11, 3766-3772 (2005).
22. Stuart, R. O. et al. In silico dissection of cell-type-associated patterns of gene expression in prostate cancer. Proc Natl Acad Sci USA 101, 615-620 (2004).
23. Wang, Y. et al. In silico estimates of tissue components in surgical samples based on expression profiling data. Cancer Res 70, 6448-6455 (2010).
24. Bhattacharjee, A. et al. Classification of human lung carcinomas by mRNA expression profiling reveals distinct adenocarcinoma subclasses. Proc Natl Acad Sci USA 98, 13790-13795 (2001).
25. West, N. P. et al. The proportion of tumour cells is an independent predictor for survival in colorectal cancer patients. Br J Cancer 102, 1519-1523 (2010).
26. Bachtiary, B. et al. Gene expression profiling in cervical cancer: an exploration of intratumor heterogeneity. Clin Cancer Res 12, 5632-5640 (2006).
27. Shedden, K. et al. Gene expression-based survival prediction in lung adenocarcinoma: a multi-site, blinded validation study. Nat Med 14, 822-827 (2008).
28. Ein-Dor, L., Zuk, O. & Domany, E. Thousands of samples are needed to generate a robust gene list for predicting outcome in cancer. Proc Natl Acad Sci USA 103, 5923-5928 (2006).
29. Michiels, S., Koscielny, S. & Hill, C. Prediction of cancer outcome with microarrays: a multiple random validation strategy. Lancet 365, 488-492 (2005).
30. Subramanian, J. & Simon, R. Gene expression-based prognostic signatures in lung cancer: ready for clinical use? J Natl Cancer Inst 102, 464-474 (2010).
31. Montanaro, L., Trere, D. & Derenzini, M. Nucleolus, ribosomes, and cancer. Am J Pathol 173, 301-310 (2008).
32. Fieller, E. C., Hartley, H. O. & Pearson, E. S. Tests for rank correlation coefficients, I. Biometrika 44, 470-481 (1957).
33. Beer, D. G. et al. Gene-expression profiles predict survival of patients with lung adenocarcinoma. Nat Med 8, 816-824 (2002).
34. Barrett, T. et al. NCBI GEO: archive for functional genomics data sets—10 years on. Nucleic Acids Res 39, D1005-1010 (2011).
35. Butts, C. A. et al. Randomized phase Ill trial of vinorelbine plus cisplatin compared with observation in completely resected stage IB and II non-small-cell lung cancer: updated survival analysis of JBR-10. J Clin Oncol 28, 29-34 (2010).
36. Stephenson, A. J. et al. Postoperative nomogram predicting the 10-year probability of prostate cancer recurrence after radical prostatectomy. J Clin Oncol 23, 7005-7012 (2005).
37. Thompson, I. M. et al. Adjuvant radiotherapy for pathological T3N0M0 prostate cancer significantly reduces risk of metastases and improves survival: long-term followup of a randomized clinical trial. J Urol 181, 956-962 (2009).
38. Wallace, T. A. et al. Tumor immunobiological differences in prostate cancer between African-American and European-American men. Cancer Res 68, 927-936 (2008).
39. Espina, V., Heiby, M., Pierobon, M. & Liotta, L. A. Laser capture microdissection technology. Expert Rev Mol Diagn 7, 647-657 (2007).
40. Park, C. C., Bissell, M. J. & Barcellos-Hoff, M. H. The influence of the microenvironment on the malignant phenotype. Mol Med Today 6, 324-329 (2000).
41. Lu, P., Nakorchevskiy, A. & Marcotte, E. M. Expression deconvolution: a reinterpretation of DNA microarray data reveals dynamic changes in cell populations. Proc Natl Acad Sci USA 100, 10370-10375 (2003).
42. Clarke, J., Seo, P. & Clarke, B. Statistical expression deconvolution from mixed tissue samples. Bioinformatics 26, 1043-1049 (2010).
43. Erkkila, T. et al. Probabilistic analysis of gene expression measurements from heterogeneous tissues. Bioinformatics 26, 2571-2577 (2010).
44. Gosink, M. M., Petrie, H. T. & Tsinoremas, N. F. Electronically subtracting expression patterns from a mixed cell population. Bioinformatics 23, 3328-3334 (2007).
45. Landesmaki, H., Shmulevich, L., Dunmire, V., Yli-Harja, O. & Zhang, W. In silico microdissection of microarray data from heterogeneous cell populations. BMC Bioinformatics 6, 54 (2005).
46. Tolliver, D., Tsourakakis, C., Subramanian, A., Shackney, S. & Schwartz, R. Robust unmixing of tumor states in array comparative genomic hybridization data. Bioinformatics 26, i106-114 (2010).
47. Venet, D., Pecasse, F., Maenhaut, C. & Bersini, H. Separation of samples into their constituents using gene expression data. Bioinformatics 17 Suppl 1, S279-287 (2001).
48. Irizarry, R. A. et al. Summaries of Affymetrix GeneChip probe level data. Nucleic Acids Res 31, e15 (2003).
49. Dai, M. et al. Evolving gene/transcript definitions significantly alter the interpretation of GeneChip data. Nucleic Acids Res. 33, e175 (2005).
50. Friedman, J., Hastie, T. & Tibshirani, R. Regularization Paths for Generalized Linear Models via Coordinate Descent. J Stat Softw 33, 1-22 (2010).
51. Wang, M. et al. Computational expression deconvolution in a complex mammalian organ. BMC Bioinformatics, 7, 328 (2006).
52. Irizarry, R. A., Hobbs, B., Collin, F., Beazer-Barclay, Y. D., Antonellis, K. J., Scherf, U., Speed, T. P. (2003). Exploration, Normalization, and Summaries of High Density Oligonucleotide Array Probe Level Data. Accepted for publication in Biostatistics.

1. A method in a processor for identifying a target molecular profile associated with a target cell population comprising:
(i) receiving data signals representing a set (β) of one or more reference molecular profiles (βₖ) each associated with at least one of one or more reference cell populations;
(ii) receiving data signals representing a set (t) of one or more sample molecular profiles (t_{d}) each associated with a sample cell (d) from a sample cell population, the sample cell population including a mixture of target cells and reference cells, each of the sample molecular profiles (t_{d}) being indicative of a respective target molecular profile (γ^{d});
(iii) calculating an estimated average target molecular profile (γ′) from the set (t);
(iv) for each sample molecular profile (t_{d}), calculating a proportion value (θ_{d}) including a proportion value (θ_{d,c}) representing a proportion of the sample molecular profile (t_{d}) that is attributable to the average target molecular profile (γ′);
(v) for each sample molecular profile (t_{d}), calculating a respective target molecular profile (γ^{d}) based on the respective calculated proportion value (θ_{d,c}) and a closest similarity to the average target molecular profile (γ′); and
(vi) providing as output data signals representing the target molecular profiles (γ^{d}).

2. The method of claim 1 wherein each sample molecular profile (t_{d}) includes n measurements of occurrences or concentrations for respective ones of a plurality of unique molecular expressions (W).

3. The method of claim 2 wherein the unique molecular expressions (W) include at least one of: unique transcripts, unique proteins, unique peptides, unique metabolites, epigenetic modifications, genetic polymorphisms and a mixture thereof.

4. The method of claim 3 wherein the transcripts correspond to at least one of: messenger RNAs, microRNAs, transfer RNAs, ribosomal RNAs, long non-coding RNAs, other RNAs, and a mixture thereof.

5. The method of claim 3 wherein occurrences or concentrations of transcripts are measured using at least one of: reverse transcriptase polymerase chain reaction (RT-PCR), NanoString nCounter assays, microarrays, nuclease protection assays, Northern blot analyses, and RNA-sequencing.

6. The method of claim 3 wherein occurrences or concentrations of at least one of: proteins, peptides and metabolites are measured using mass spectrometry.

7. The method of claim 3 wherein the genetic polymorphisms include at least one of: single nucleotide polymorphisms, copy number variations, small insertions, small deletions, and mixtures thereof.

8. The method of claim 3 wherein occurrences or concentrations of genetic polymorphism are measured using at least one of: microarrays and sequencing.

9. The method of claim 1 wherein (iii) comprises calculating (γ′) by constraining (γ′) to be close to a predefined prior mean vector.

10. The method of claim 1 wherein (iv) comprises calculating (θ_{d}) by constraining each (θ_{d}) to be close to an average (α) of all (θ_{d}).

11. The method of claim 1 wherein (iv) comprises calculating (θ_{d}) by assuming the average target molecular profile (γ′) is representative of each target molecular profile (γ^{d}).

12. The method of claim 1 wherein the set (β) is used to define a reference molecular profile space comprising a set of reference weighted averages (ωβ), where all values of (ω) are non-negative and the sum of all (ω) equal to one, and (iii) comprises calculating an estimate of the average target molecular profile (γ′) by:
constraining the average target molecular profile (γ′) to maximize a probability that each sample molecular profile (t_{d}) is generated based on a combination of the set of reference molecular profiles (β) and the average target molecular profile (γ′); and
constraining the average molecular profile (γ′) to be close to the set of reference weighted averages (ωβ).

13. The method of claim 1 further comprising calculating a proportion value (θ_{d,k}) representing a proportion of each reference molecular profile (βₖ) expressed in that sample molecular profile (t_{d}).

14. The method of claim 1 wherein (v) comprises calculating the target molecular profile (γ^{d}) by:
constraining the target molecular profile (γ^{d}) to maximize a probability that the sample molecular profile (t_{d}) is generated based on a combination of the set of reference molecular profiles (β) and the target molecular profile (γ^{d});
using the proportion value (θ_{d,c}) from (d); and
constraining the target molecular profile (γ^{d}) to be close to the average target molecular profile (γ′).

15. A method in a processor for identifying at least one biomarker associated with a target cell population comprising:
(i) receiving data signals representing a set (β) of one or more reference molecular profiles (βₖ) each associated with a respective one of one or more reference cell populations;
(ii) receiving data signals representing a set (γ) of one or more target molecular profiles (γ_{d}) associated with the target cell population, the target molecular profiles (γ_{d}) being obtained according to the method of claim 1;
(iii) receiving data signals representing a set (p) of at least one attribute associated with at least one target molecular profile (γ_{d});
(iv) comparing the set (γ) to the set (β) to determine the at least one biomarker for predicting the at least one attribute; and
(v) generating output signals representing the at least one determined biomarker.

16. The method of claim 15 further comprising using the at least one biomarker to distinguish a cell from the reference cell population from a cell from the target cell population.

17. The method of claim 15 wherein any attributes associated with one target molecular profile are independent of any attributes associated with another target molecular profile.

18. The method of claim 15 wherein at least one target molecular profile has no associated attribute in the set (p).

19. A system for identifying a target molecular profile associated with a target cell population comprising a processor configured to execute computer-executable instructions to cause the processor to:
(i) receive data signals representing a set (β) of one or more reference molecular profiles (βₖ) each associated with at least one of one or more reference cell populations;
(ii) receive data signals representing a set (t) of one or more sample molecular profiles (t_{d}) each associated with a sample cell (d) from a sample cell population, the sample cell population including a mixture of target cells and reference cells, each of the sample molecular profiles (t_{d}) being indicative of a respective target molecular profile (γ^{d});
(iii) calculate an estimated average target molecular profile (γ′) from the set (t);
(iv) for each sample molecular profile (t_{d}), calculate a proportion value (θ_{d}) including a proportion value (θ_{d,c}) representing a proportion of the sample molecular profile (t_{d}) that is attributable to the average target molecular profile (γ′);
(v) for each sample molecular profile (t_{d}), calculate a respective target molecular profile (γ^{d}) based on the respective calculated proportion value (θ_{d,c}) and a closest similarity to the average target molecular profile (γ′); and
(vi) provide as output data signals representing the calculated target molecular profiles (γ^{d}).

20. The system of claim 19 further comprising a database accessible by the processor, the database storing data for at least one of the one or more reference molecular profiles (βₖ).

21. The system of claim 19 further comprising a database accessible by the processor, the database storing data for at least one of the plurality of sample molecular profiles (t_{d}).

22.-37. (canceled)
